(19) United States
(12) Patent Application Publication
(10) Pub. No.: US 2004/0236632 A1
(43) Pub. Date: Nov. 25, 2004

(54) System and method for conducing financial transactions using a personal transaction device with vehicle-accessed, payment-gateway terminals

(76) Inventors: Michael L. Maritzen, Fremont, CA (US); Hiro Yasuda, Woodcliff Lake, NJ (US); Robert Tanner, Boulder Creek, CA (US); Harold Aaron Ludtke, San Jose, CA (US)

Correspondence Address: Rogitz & Associates, 750 B Street, Suite 3120, San Diego, CA, 92101, US

(21) Appl. No.: 10/015,724

(22) Filed: Dec. 6, 2001

Related U.S. Application Data
(60) Provisional application No. 60/254,217, filed on Dec. 7, 2000.

(51) Int. Cl. G06F 17/60

(52) U.S. Cl. 705/26

(57) ABSTRACT

A system and method for conducting a financial transaction are described. In one embodiment, communication is established between a vehicle-accessed, payment-gateway terminal (VAPGT) and a pre-registered, key-enabled, personal transaction device (PTD). The PTD is accessed using a privacy card and a transaction request is transmitted to a server. Further, a transaction authorization message is received from the server to complete the transaction.

In an alternate embodiment, a pre-registered, key-enabled, personal transaction device (PTD) is loaded with a pre-funded cash account. Further, communication is established between a vehicle-accessed, payment-gateway terminal (VAPGT) and the PTD and the PTD is accessed using a privacy card. Finally, a transaction amount is deducted from the pre-funded cash account to complete the transaction.

### RELATED APPLICATIONS

The present application claims the benefit of U.S. Provisional Patent Application Ser. No. 60/254,217, filed on Dec. 07, 2000, and entitled “METHOD AND APPARATUS FOR PRIVATE/ANONYMOUS WIRELESS, AUTOMATED PAYMENT AND SETTLEMENT OF TOLLS, FEES, SERVICE CHARGES AND RELATED FOR VEHICLES IN REAL-TIME AT A TOLLBOOTH SMOG CERTIFICATION STATION AND SIMILAR KIOSK ENABLED VIA A PKI-BASED BIOMETRIC IDENTIFIER” which is herein incorporated by reference in its entirety.

### FIELD OF THE INVENTION

The present invention relates generally to conducting financial transactions, and, more particularly, to a system and method to conduct financial transactions with a personal transaction device at vehicle-accessed, payment-gateway terminals.

### BACKGROUND OF THE INVENTION

With the introduction of credit cards and pre-paid cash cards, society has moved from a cash-based to a cash-free society. However, there are still situations that require the use of cash to carry out financial transactions. A situation that still requires use of cash is in the collection of fees at vehicle-accessed payment gateways such as tollbooths, vehicular kiosks, smog-certification stations, and the like. The collection of fees at these gateways is time consuming and subject to fraud.

Systems for the electronic payment of fees at payment gateways have been developed using fixed sensors interacting remotely with devices carried by passing vehicles or persons. Such systems incorporate, for example, a pre-paid token or card in the devices in which the fee is deducted from the device.

These systems offer anonymity but are inflexible as a device needs to be purchased for each specific financial transaction to be conducted. In addition, the financial transactions are insecure and are not fund-transfer transactions. In addition, these systems do not offer real-time settlement of transactions. Finally, if the device is stolen, the funds may be used by anyone in possession of the device.

What is required is a system and method for the real-time settlement of vehicle-accessed, financial transactions that provide anonymity and security.

### SUMMARY OF THE INVENTION

A system and method for conducting a financial transaction are described. In one embodiment, communication is established between a vehicle-accessed, payment-gateway terminal (VAPGT) and a pre-registered, key-enabled, personal transaction device (PTD). The PTD is accessed using a privacy card and a transaction request is transmitted to a server. Further, a transaction authorization message is received from the server to complete the transaction.

In an alternate embodiment, a pre-registered, key-enabled, personal transaction device (PTD) is loaded with a pre-funded cash account. Further, communication is established between a vehicle-accessed, payment-gateway terminal (VAPGT) and the PTD and the PTD is accessed using a privacy card. Finally, a transaction amount is deducted from the pre-funded cash account to complete the transaction.

Other features and advantages of the present invention will be apparent from the accompanying drawings and from the detailed description that follows.

### BRIEF DESCRIPTION OF THE DRAWINGS

Features and advantages of the present invention will be apparent to one skilled in the art in light of the following detailed description in which:

FIG. 1 is a block diagram of one embodiment for a financial transaction system;

FIG. 2 is a block diagram for one embodiment of an architecture for a personal transaction device;

FIG. 3 is a block diagram for one embodiment of a non-volatile memory for FIG. 2;

FIG. 4 is a block diagram for one embodiment of a privacy card for FIG. 1;

FIG. 5 is a block diagram for one embodiment of PTD memory of FIG. 4;

FIGS. 6a and 6b are examples of a personal transaction device with integrated privacy card;

FIG. 7 is an example of a privacy card;

FIG. 8 is a block diagram for one embodiment of an architecture for a clearing house for FIG. 1;

FIG. 9 is a block diagram for one embodiment of a user area of FIG. 8;

FIG. 10 is a block diagram for one embodiment of a transaction area of FIG. 8;

FIG. 11 is a flow diagram for one embodiment of a method for conducting a financial transaction;

FIG. 12 is a flow diagram for a second embodiment of a method for conducting a financial transaction by a personal transaction device;

FIG. 13 is a flow diagram for one embodiment of a method for conducting a financial transaction by a personal transaction device;

FIG. 14 is a flow diagram for one embodiment of a method for conducting a financial transaction by a vehicle-accessed, payment gateway terminal;

FIG. 15 is a flow diagram for one embodiment of a method for conducting a financial transaction by a clearing house;

FIG. 16 is a flow diagram for a third embodiment of a method for conducting a financial transaction;

FIG. 17 is a flow diagram for a fourth embodiment of a method for conducting a financial transaction; and

FIG. 18 is a flow diagram for a second embodiment of a method for conducting a financial transaction by a vehicle-accessed, payment gateway terminal.

### DETAILED DESCRIPTION

A system and method for conducting a financial transaction are described. In one embodiment, communication is established between a vehicle-accessed, payment-gateway terminal (VAPGT) and a pre-registered, key-enabled, personal transaction device (PTD). The PTD is accessed using a biometric control and a transaction request is transmitted to a server. Further, a transaction authorization message is received from the server to complete the transaction in real time between the user and the VAPGT provider. In this embodiment, the funds are uniquely identified with the owner of the PTD and, thus, if the PTD is stolen, the funds cannot be used by another user.

In an alternate embodiment, a pre-registered, key-enabled, personal transaction device (PTD) is loaded with a pre-funded cash account. Further, communication is established between a vehicle-accessed, payment-gateway terminal (VAPGT) and the PTD and the PTD is accessed using a biometric control. Finally, a transaction amount is deducted from the pre-funded cash account to complete the transaction in real time between the user and the VAPGT provider. In this embodiment, the funds are uniquely identified with the owner of the PTD and, thus, if the PTD is stolen, the funds cannot be used by another user.

The embodiments described herein provide for secure, anonymous, real time settlement of financial transactions. In addition, the embodiments provide consistency and commonality in the key stages of the financial transaction capturing and processing lifecycle. This may provide in a cost reduction in the physical hardware required by eliminating some components from the current vehicle-based communication system by consolidating the components into the PTD. For example, reducing the need for separate tollbooth payment tokens within the vehicle. In addition, the embodiments may provide for consistent levels of security and other services across multiple payment gateways by use of a common transaction service provider. Also, the embodiments may provide strong integration with a user's devices and other utilities such as, for example, financial reporting tools such as tax preparation, expense report generation, and the like.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

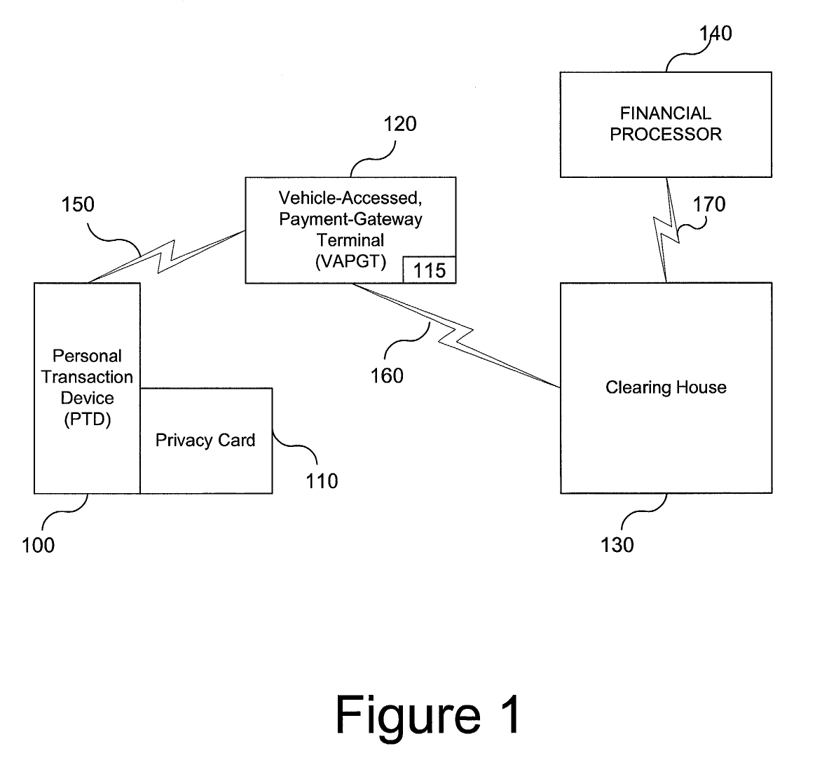

FIG. 1 is a block diagram of one embodiment for a financial transaction system 180. Referring to FIG. 1, a personal transaction device (PTD) 100 communicates via communication link 150 with a vehicle-accessed, payment-gateway terminal (VAPGT) 120 to conduct a financial transaction. In one embodiment, the PTD 100 is a pre-registered, key-enabled, personal transaction device. In one embodiment, PTD 100 is a public-key infrastructure (PKI) enabled device. In one embodiment, PTD 100 is registered with an appropriate enabling authority prior to initiation of the financial transaction. The appropriate enabling authority may be, for example, a financial institution, a third party distributor, a credit card issuer, or the like. In one embodiment, PTD 100 is associated with a particular user such that only the particular user may access PTD 100 and conduct the financial transaction using PTD 100. Alternatively, a number of users may use PTD 100, each user having a unique biometric key associated with the user and PTD 100.

VAPGT 120 may be any vehicle-accessed terminal such as, for example, a tollbooth, a vehicular kiosk, a ticket-booth, a smog-certification station, or the like. In one embodiment, VAPGT 120 includes VAPGT memory 115 for the storage of financial transaction data such as, for example, a payment request and a transaction request. VAPGT 120 communicates via communication link 160 with clearing house 130. Clearing house 130 may be any appropriate server. Clearing house 130 communicates via communication link 170 with financial processor 140. In one embodiment, PTD 100 is connected to privacy card 110. In one embodiment, PTD 100 and privacy card 110 may be within the same device. In an alternate embodiment, PTD 100 and privacy card 110 may be separate devices that are connected by any suitable means. In this alternate embodiment, PTD 100 and privacy card 110 may be connected via a hardwired connection. Alternatively PTD 100 and privacy card 110 may communicate via a wireless connection. In one embodiment, privacy card 110 may be fully integrated into PTD 100.

Transmission via communication link 150 may be via wireless communication such as, for example, Bluetooth, infrared, wireless LAN, or the like. VAPGT 120 may be connected to clearing house 130 via a hardwired communication link such as, for example, a virtual private network (VPN), telephone connection, wide area network (WAN) or the like. Alternatively, VAPGT 120 and clearing house 130 may be connected via a wireless communication link such as, for example, a mobile telecommunications link, a radio communications link, an infrared link, a satellite link, a wireless WAN link, or the like. In one embodiment, VAPGT 120 and clearing house 130 are remotely connected.

As PTD 100 nears VAPGT 120, the proximity of PTD 100 to VAPGT 120 is recognized. In one embodiment, VAPGT 120 may sense the proximity of PTD 100 and initiate communication with the PTD 100. In an alternate embodiment, PTD 100 may sense the proximity of VAPGT 120 and initiate communication with VAPGT 120. Any of a variety of well-known methods for sensing the proximity of the two devices may be used. For example, VAPGT 120 may periodically poll the surrounding area to determine the proximity of a PTD 100.

To conduct a financial transaction, once the PTD 100 and VAPGT 120 are within proximity to each other, VAPGT 120 sends a payment request via communication link 150 to PTD 100. In one embodiment, the payment request may include a transaction type, a transaction amount, and a VAPGT identifier. Alternatively, any suitable information may be included in the payment request. Once PTD 100 receives the payment request from VAPGT 120, the user accesses privacy card 110 to access PTD 100. In an alternate embodiment, a user may access privacy card 110 prior to the initiation of the financial transaction. For example, the user may access privacy card 110 to enter a vehicle or to start the vehicle.

In one embodiment, privacy card 110 is a biometric control. A suitable biometric control device that may be used is described in U.S. patent application Ser. No. 09/610,811 entitled “Method of Using Personal Device With Internal Biometric In Conducting Transactions Over A Network”, which is herein incorporated by reference. In one embodiment, the user accesses privacy card 110 using a finger or thumbprint input. Alternatively, any means of biometric access may be used. Privacy card 110 uses the biometric input to verify the user of the device. Only a registered user may access PTD 100 via privacy card 110.

In one embodiment, if the biometric input is valid for the device, privacy card 110 creates a biometric key that is transmitted to PTD 100. If privacy card 110 is within PTD 100, validation of the biometric information may be conducted by PTD 100. Alternatively, if privacy card 110 is separate from PTD 100, validation is conducted by privacy card 110. Privacy card 110 only transmits the biometric key. The biometric information identifying the user is not transmitted at any time. The biometric key is used to unlock PTD 100 and to gain authorization of the financial transaction.

In one embodiment, the biometric key is encrypted using well-known encryption technology such as, for example, PKI encryption. If the biometric key is valid, PTD 100 creates a transaction key. In one embodiment, the transaction key may include the biometric key and a PTD identifier. The PTD identifier identifies the particular PTD being used. In an alternate embodiment, the transaction key includes only the biometric key. In one embodiment, PTD 100 transmits the transaction key via communication link 150 to VAPGT 120. PTD 100 does not transmit any user information to VAPGT 120. In one embodiment, the transaction key is encrypted prior to transmission using standard encrypting methods such as, for example, public key infrastructure (PKI) encryption.

Once VAPGT 120 receives the transaction key, VAPGT 120 generates a transaction request. In one embodiment, the transaction request includes the transaction key, a transaction amount, a transaction type, and a terminal identifier. The terminal identifier identifies a particular VAPGT 120. In alternate embodiments, the transaction request may include other information. The transaction request is transmitted via communication link 160 to clearing house 130. In one embodiment, the transaction request may be encrypted using well-known encrypting methods such as, for example, PKI encryption.

Clearing house 130 determines if the transaction type is valid for a particular user. In one embodiment, clearing house 130 decrypts the transaction request and, if required, the transaction key. In one embodiment, clearing house 130 determines if the transaction type is consistent with historical transaction events conducted by the user. In addition, clearing house 130 may compare the current transaction type against pre-established user certificates and profiles. In an alternate embodiment, clearing house 130 may compare the transaction type against fraud detection systems. Any of a variety of well-known fraud detection systems may be used. Any or all of the above verifications may be performed.

In addition, clearing house 130 may validate the transaction key against pre-existing user keys. In one embodiment, the user may set-up specific keys to conduct specific financial transactions. For example, the user may set up a specific key for conducting tollbooth financial transactions. In an alternate embodiment, one transaction key may be used for all vehicle-accessed financial transactions. In one embodiment, clearing house 130 compares the transaction key against a list of keys associated with the particular user. In one embodiment, the list of keys may be maintained within clearing house 130. If a match is found, then the transaction key is valid. Clearing house 130 also verifies that the biometric key is valid by comparison of the biometric key transmitted to clearing house 130 with a known biometric key maintained within clearing house 130.

Once clearing house 130 determines that the transaction type and transaction key are valid, clearing house 130 selects a pre-existing account from a number of user accounts associated with the PTD 100 and the user to process the financial transaction. In one embodiment, a list of accounts associated with PTD 100 may be maintained on clearing house 130. In one embodiment, clearing house 130 selects an account associated with the transaction key.

Once the transaction account is selected, clearing house 130 negotiates with a financial processor 140 to authorize the transaction. Clearing house 130 creates an account query to be transmitted via communication link 170 to financial processor 140. In one embodiment, the account query may include an account number, the transaction amount, and an account key. The account key may be an encrypted key used to verify the account number by the financial processor 140. In one embodiment, the account key is set-up by the user when PTD 100 is registered with the appropriate enabling authority. In one embodiment, the account query is encrypted using well-know encryption technology such as, for example, PKI encryption. Although FIG. 1 includes a single financial processor 140, any other number of financial processor's may be connected to clearing house 130. In one embodiment, the selected account is specific to financial processor 140.

Financial processor 140 verifies the account and deducts the transaction amount from the selected account. In one embodiment, financial processor 140 verifies that the account number and account key match and that the account has sufficient funds for the financial transaction. If the account is valid and sufficient funds exist, financial processor 140 creates an account authorization message and transmits the account authorization message via communication link 170 to clearing house 130. If the account query is invalid or if there are insufficient funds in the account, financial processor 140 transmits an invalid account message to clearing house 130.

In one embodiment, the account authorization message does not contain any account information. Only an authorization to proceed with the financial transaction is transmitted from financial processor 140 to clearing house 130. In an alternate embodiment, the account information may be contained entirely within clearing house 130 and all account authorization may be conducted from within clearing house 130.

In one embodiment, if the transaction is authorized by financial processor 140, the transaction amount is credited to an account for VAPGT 120. In one embodiment, clearing house 130 negotiates with a financial processor 140 associated with VAPGT 120 to credit an account for the financial transaction. In an alternate embodiment, VAPGT 120 negotiates to credit the appropriate account.

Once the account is authorized, clearing house 130 transmits a transaction authorization message via communication link 160 to VAPGT 120. The transaction authorization message allows the financial transaction to be completed. Once VAPGT 120 receives the transaction authorization message, the transaction is completed. In one embodiment, the transaction authorization message allows the user to pay a toll at a tollbooth or similar transaction. The transaction authorization message does not include any financial processor 140 or user information. Only an authorization to proceed with the financial transaction is transmitted from clearing house 130 to VAPGT 120. Thus, VAPGT 120 does not obtain information as to who the user is, who the financial processor 140 is, or the account being used. Thus the privacy of both the user and the financial processor is maintained.

If the transaction is not valid or the financial processor 140 does not authorize the account for use, an invalid transaction message is transmitted from clearing house 130 to VAPGT 120. In one embodiment, appropriate policing authorities are notified of the invalid transaction. Appropriate policing authorities may include, for example, a local Police Department, the FBI, the appropriate enabling authority, or the like. One, all, or a combination of many appropriate policing authorities may be contacted. In one embodiment, PTD 100 notifies the appropriate policing authorities. In an alternate embodiment, VAPGT 120 notifies the appropriate policing authorities. In yet another alternate embodiment, clearing house 130 notifies the appropriate policing authorities.

In one embodiment, the invalid transaction message disables the PTD 100. PTD 100 is disabled such that the user may not access PTD 100. Alternatively, PTD 100 may be disabled such that no user may access PTD 100. In one embodiment, the appropriate enabling authority is notified that PTD 100 has been disabled.

In one embodiment, if the account contains insufficient funds, clearing house 130 transmits an insufficient funds message to VAPGT 120. In this embodiment, the user may be notified of the insufficient funds on a PTD 100 display. The user may be offered the opportunity to choose a different account to conduct the financial transaction. In this embodiment, the user may select a different account from an list of accounts displayed on PTD 100 or enter an account number into PTD 100. Alternatively, the user may pay the transaction amount by any other appropriate means such as, for example, cash, credit card, or the like.

In an alternate embodiment, a stand-in processor may be locally connected to VAPGT 120 to authorize the financial transaction. In this alternate embodiment, the stand-in processor allows the authorization of financial transactions up to a pre-determined value (“floor limits”). Alternatively, the stand-in processor may be local to the vehicle (for example, in the case of a rental car). The authorization occurs locally to VAPGT 120 and does not require the interaction of clearing house 130 to authorize the financial transaction. The transaction request is received from VAPGT 120 and the stand-in processor validates the transaction type and the transaction key as described above. The stand-in processor sends the transaction authorization message or invalid transaction message to VAPGT 120 as described above. In addition, the stand-in processor sends a message to clearing house 130 to settle the account.

In yet another alternate embodiment, PTD 100 may connect with clearing house 130 directly to transmit the transaction key. In this embodiment, VAPGT 120 transmits the transaction request separate from the transaction key to clearing house 130. Clearing house 130 combines the transaction key and transaction request in order to validate the financial transaction. In addition, clearing house 130 transmits the transaction authorization message or invalid transaction message to both VAPGT 120 and PTD 100 in order to complete the financial transaction.

In a second embodiment, the transaction authorization message is generated entirely within PTD 100. In this embodiment, a pre-funded cash account is loaded into PTD 100 prior to initiation of the financial transaction. In this embodiment, the transaction request is transmitted from VAPGT 120 via communication link 150 to PTD 100. PTD 100 verifies that the transaction is valid and that enough cash is remaining in the pre-funded cash account. If the transaction is valid and enough cash remains, PTD 100 deducts the transaction amount from the cash account and transmits a transaction authorization message via communication link 150 to VAPGT 120 to complete the transaction. In this embodiment, mutual trust is generated between PTD 100 and VAPGT 120 by any well-known means.

If the transaction is not valid, PTD 100 transmits an invalid transaction message to VAPGT 120. In one embodiment, appropriate policing authorities are notified of the invalid transaction. In one embodiment, PTD 100 notifies the appropriate policing authorities. In an alternate embodiment, VAPGT 120 notifies the appropriate policing authorities. In one embodiment, if the transaction is not valid, PTD 100 is disabled.

In one embodiment, if not enough money is contained within the pre-funded cash account, the user is notified of this on a PTD 100 display. In addition, VAPGT 120 is notified that not enough cash is remaining. By notifying the user of the lack of cash within the pre-funded account, the user may pay the transaction amount by any other appropriate means such as, for example, cash, credit card, or the like.

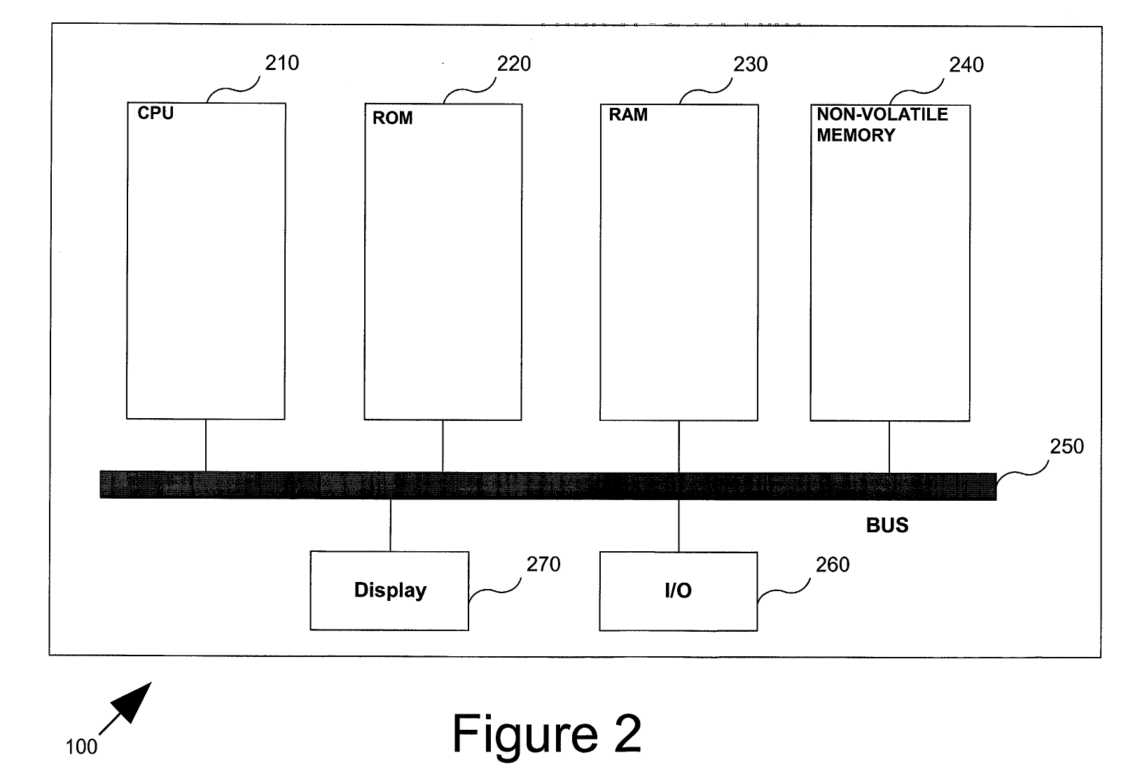

FIG. 2 is a block diagram for one embodiment of an architecture for personal transaction device (PTD) 100. Referring to FIG. 2, CPU 210 is coupled via bus 250 to a variety of memory structures, input/output (I/O) 260, and display 270. The memory structures may include read only memory (ROM) 220, random access memory (RAM) 230, and/or non-volatile memory 240. CPU 210 is configured to execute instructions to perform the functionality described herein. The executable instructions may be stored in an appropriate memory structure. The memory structures may also be configured to store data, such as transaction data and the like. Alternatively, CPU 210 may be replaced with specially configured logic to perform the functions described herein.

In one embodiment, I/O 270 includes a coupling input to connect PTD 100 to privacy card 110. In one embodiment, CPU 210 may also be coupled via bus 250 to a network interface and I/O 270. The network interface may be used to communicate between PTD 100 and a variety of other computers via a wide area network such as, for example, the Internet or communicate over a local area network. The network interface may be used to communicate between PTD 100 and VAPGT 120. The network interface may be coupled to a wide area network by any of a variety of means such as, for example, a wireless telecommunications network, a wireless WAN network, a telephone connection via modem, a DSL line, or the like. The network interface may be coupled to VAPGT 120 by any of a variety of wireless means such as, for example, a Bluetooth connection, a wireless LAN connection, a mobile telecommunications connection, an infrared connection, or the like.

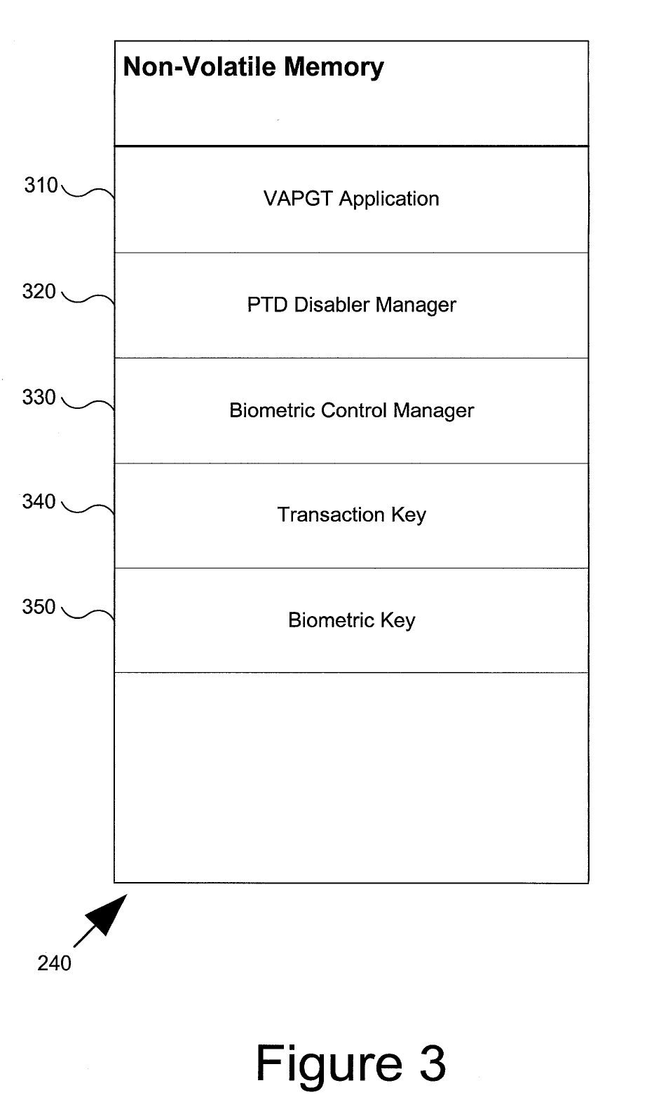

FIG. 3 is a block diagram of one embodiment of non-volatile memory 240 of FIG. 2. Referring to FIG. 3, non-volatile memory 240 contains VAPGT application 310, PTD disabler manager 320, biometric control manager 330, transaction key 340, and biometric key 350. VAPGT application 310 includes computer readable instructions used by CPU 210 to conduct financial transactions with VAPGT 120. Alternatively, VAPGT application 310 may be replaced with specially configured logic to perform the functions described herein.

PTD disabler manager 320 includes computer readable instructions used by CPU 210 to disable PTD 100 if an invalid transaction message is received. In addition, PTD disabler manager 320 may be used to notify appropriate policing authorities if an invalid transaction message is received. Alternatively, PTD disabler manager 320 may be replaced with specially configured logic to perform the functions described herein.

Biometric control manager 330 includes computer readable instructions used by CPU 210 to receive biometric information from privacy card 110, verify the biometric information, and unlock PTD 100. Alternatively, biometric control manager 330 may be replaced with specially configured logic to perform the functions described herein.

Transaction key 340 is used to temporarily store transaction key information to be sent to VAPGT 120. Biometric key 350 is used to temporarily store the biometric key received from privacy card 110. In an alternate embodiment, biometric key 350 and biometric control manager 330 may be located within privacy card 110 as either computer readable instructions or specially configured logic to perform the functions described herein.

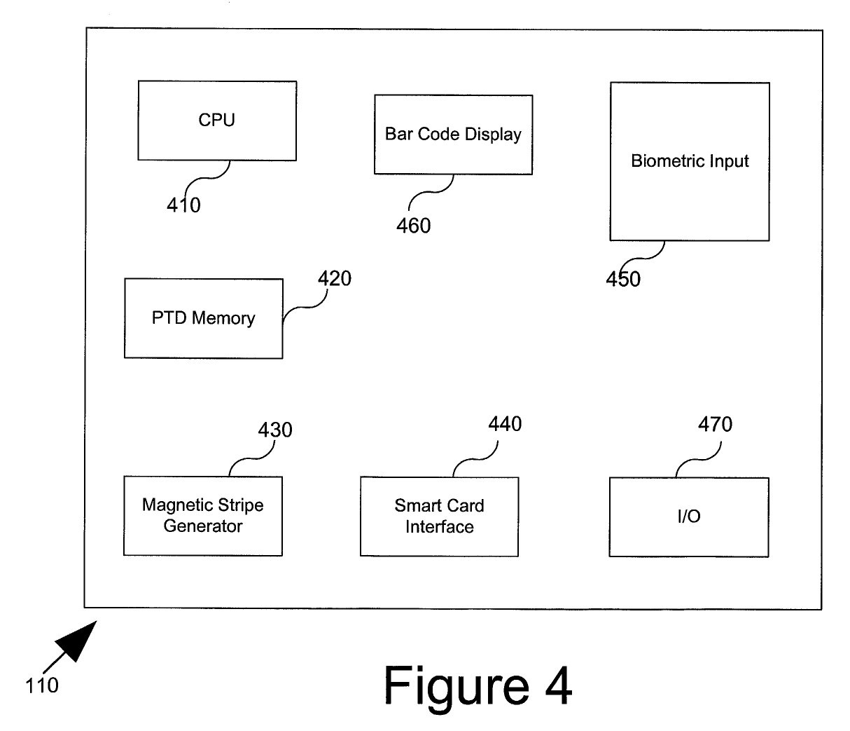

FIG. 4 is a block diagram of one embodiment for a privacy card 110. Referring to FIG. 4, the card 110 is configured, in one embodiment, to be the size of a credit card. In one embodiment, privacy card 110 is a biometric control device. The privacy card includes CPU 410, PTD memory 420, and input/output (I/O) logic 470. CPU 410 may be configured to execute instructions to perform the functionality herein. The instructions may be stored in PTD memory 420. PTD memory 420 may also be configured to store data, such as transaction data and the like. In one embodiment, PTD memory 420 stores biometric key 350 used to perform transactions in accordance with the embodiments described herein. Alternately, CPU 410 may be replaced with specially configured logic to perform the functions described here.

I/O logic 470 is configured to enable the privacy card 110 to send and receive information. In one embodiment, I/O logic 470 may be configured to communicate through a wired or contact connection. In an alternate embodiment, I/O logic 470 may be configured to communicate through a wireless or contactless connection. A variety of communication technologies may be used.

In one embodiment, bar code display 460 is used to generate bar codes scanable by coupled devices and may be used to perform processes as described herein. Privacy card 110 may also include magnetic stripe generator 430 to simulate a magnetic stripe readable by devices such as legacy POS terminals or a legacy VAPGT 120.

In one embodiment, biometric information, such as fingerprint recognition, is used as a security mechanism that limits access to the card 110 to authorized users. Biometric input 450 is therefore included in one embodiment to perform these functions. Alternately, security may be achieved using smart card interface 440 that uses known smart card technology to perform the functions described herein.

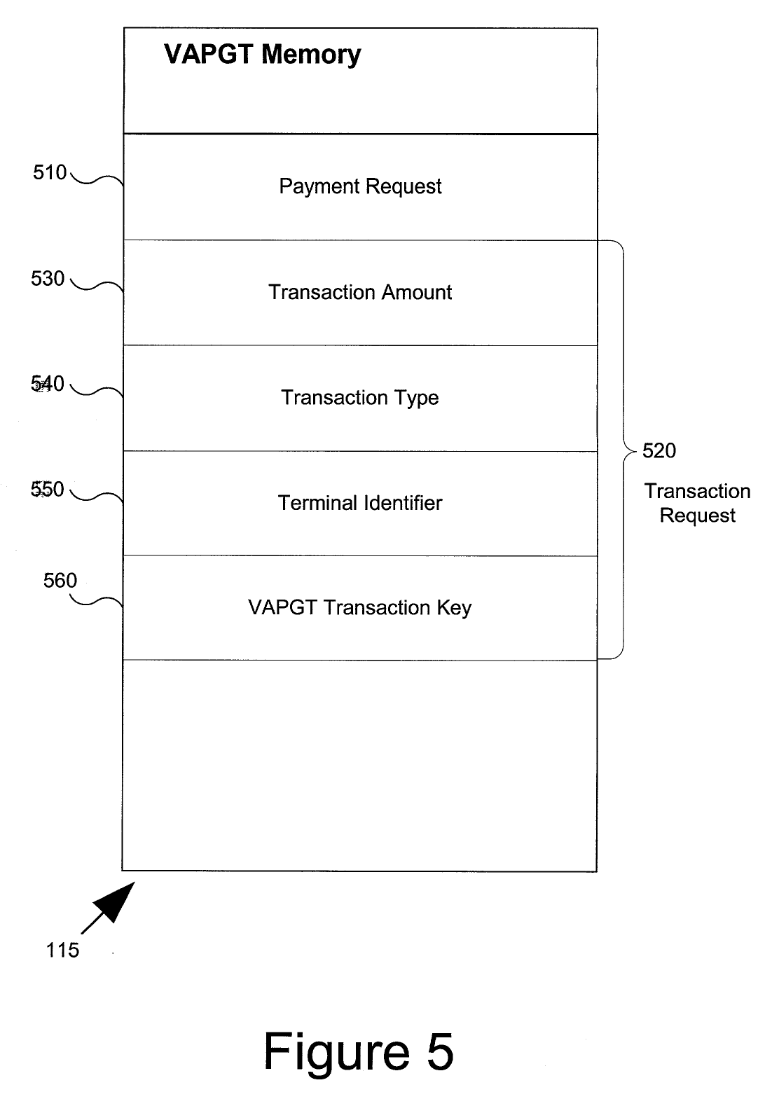

FIG. 5 is a block diagram of one embodiment for VAPGT memory 115. Referring to FIG. 5, VAPGT memory 115 includes payment request 510 and transaction request 520. Payment request 510 is sent to PTD 100 after a communication link is established between PTD 100 and VAPGT 120 to conduct the financial transaction.

Transaction request 520 includes, in one embodiment, transaction amount 530, transaction type 540, terminal identifier 550, and VAPGT transaction key 560. Transaction request 520 is generated after receipt of transaction key 340, which is stored in VAPGT transaction key 560.

Terminal identifier 550 is a unique identification number that identifies VAPGT 120. Transaction type 540 indicates the type of financial transaction being conducted. For example, transaction type 540 may indicate that a tollbooth financial transaction is being conducted. Transaction amount 530 is the currency amount of the financial transaction.

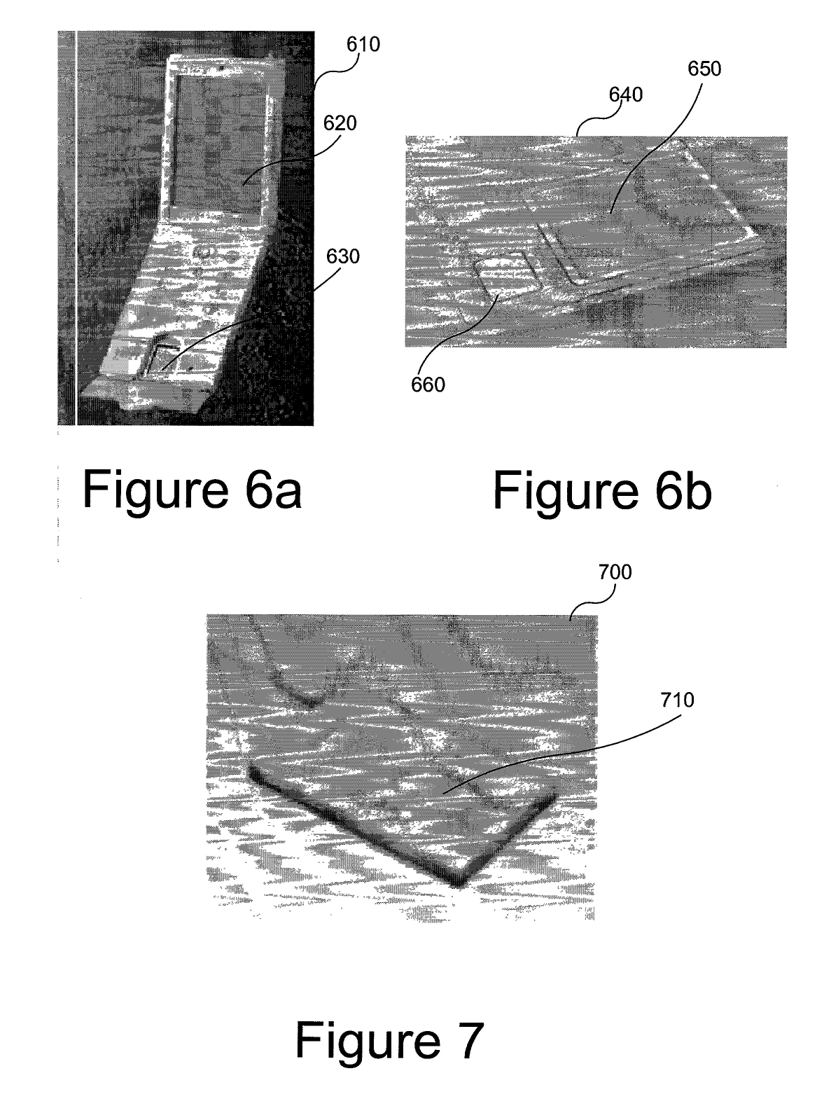

FIGS. 6a and 6b are examples of personal transaction devices 610, 640 with integrated privacy card 110. PTD 610 illustrates biometric input 630 together with display 620. PTD 640 illustrates biometric input 660 and display 650.

FIG. 7 is an example of a privacy card 700. FIG. 7 illustrates a stand only privacy card 110 in the form of a biometric input device. Privacy card 700 includes biometric input 710.

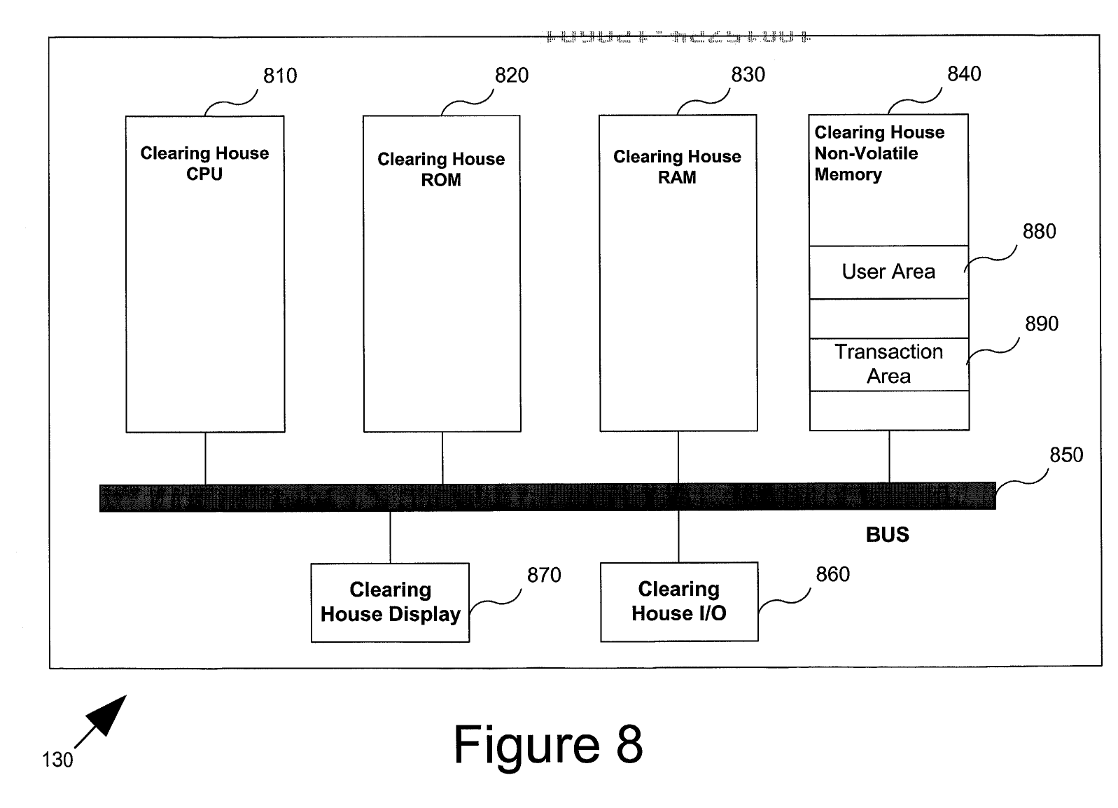

FIG. 8 is a block diagram for one embodiment of an architecture for clearing house 130. Referring to FIG. 8, clearing house 130 includes clearing house CPU 810 coupled via clearing house bus 850 to a variety of memory structures, clearing house input/output (I/O) 860, and clearing house display 870. Any appropriate server may be used for clearing house 130. The memory structures may include clearing house read only memory (ROM) 820, clearing house random access memory (RAM) 830, and/or clearing house non-volatile memory 840. Clearing house CPU 810 is configured to execute instructions to perform the functionality described herein. The executable instructions may be stored in an appropriate memory structure. The memory structures may also be configured to store data, such as user area 880 and transaction area 890. In an alternate embodiment, user area 880 may be maintained on a separate server connected to clearing house 130. Alternatively, clearing house CPU 810 may be replaced with specially configured logic to perform the functions described herein.

In one embodiment, clearing house CPU 810 may also be coupled via clearing house bus 850 to a network interface and clearing house I/O 860. The network interface may be used to communicate with PTD 100, VAPGT 120, financial processor 140, and a variety of other computers via a wide area network such as, for example, the Internet or communicate over a local area network. The network interface may be coupled to a wide area network by any of a variety of means such as, for example, a wireless telecommunications network, a wireless WAN network, a telephone connection via modem, a DSL line, or the like. The network interface may be coupled to PTD 100, VAPGT 120, and financial processor 140 by any of a variety of wireless means such as, for example, a Bluetooth connection, a wireless LAN connection, a mobile telecommunications connection, an infrared connection, or the like.

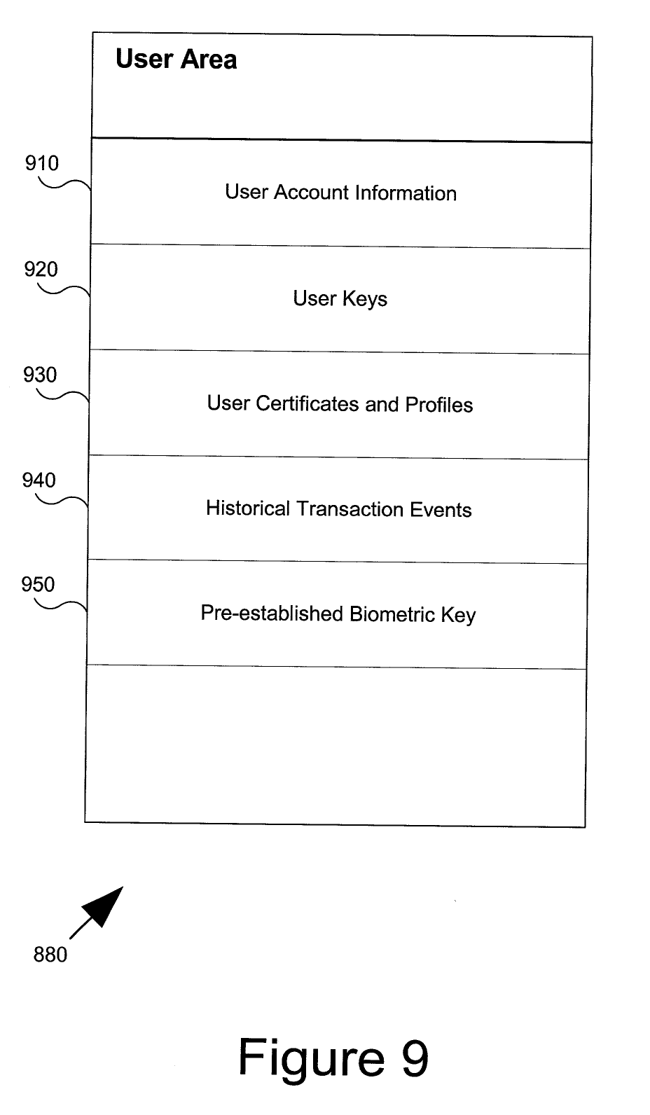

FIG. 9 is a block diagram for one embodiment of user area 880. Referring to FIG. 9, user area 880 includes user account information 910, user keys 920, user certificates and profiles 930, historical transaction events 940, and pre-established biometric key 950. In one embodiment, clearing house 130 selects a pre-existing account from a number of user accounts maintained within user account information 910. In one embodiment, user account information 910 is pre-established by the user prior to conducting financial transactions with PTD 100. The pre-existing account is associated with the PTD 100 to process the financial transaction. In one embodiment, clearing house 130 selects an account associated with transaction request 520. Once the transaction account is selected, clearing house 130 negotiates with a financial processor 140 to authorize the financial transaction.

In one embodiment, clearing house 130 determines if transaction type 540 is consistent with historical transaction events 940 conducted by the user. In addition, clearing house 130 may compare the current transaction type against pre-established user certificates and profiles 930. In addition, clearing house 130 may validate transaction key 340 against pre-existing user keys 920. In one embodiment, the user may set-up specific keys to conduct specific financial transactions that may be stored in user keys 920 prior to conducting financial transactions with PTD 100. For example, the user may set up a specific key for conducting tollbooth financial transactions. In an alternate embodiment, one user key 920 may be used for all vehicle-accessed financial transactions. In one embodiment, clearing house 130 compares transaction key 340 against user keys 920. If a match is found, then transaction key 340 is valid. Clearing house 130 also validates biometric key 350 against pre-established biometric key 950.

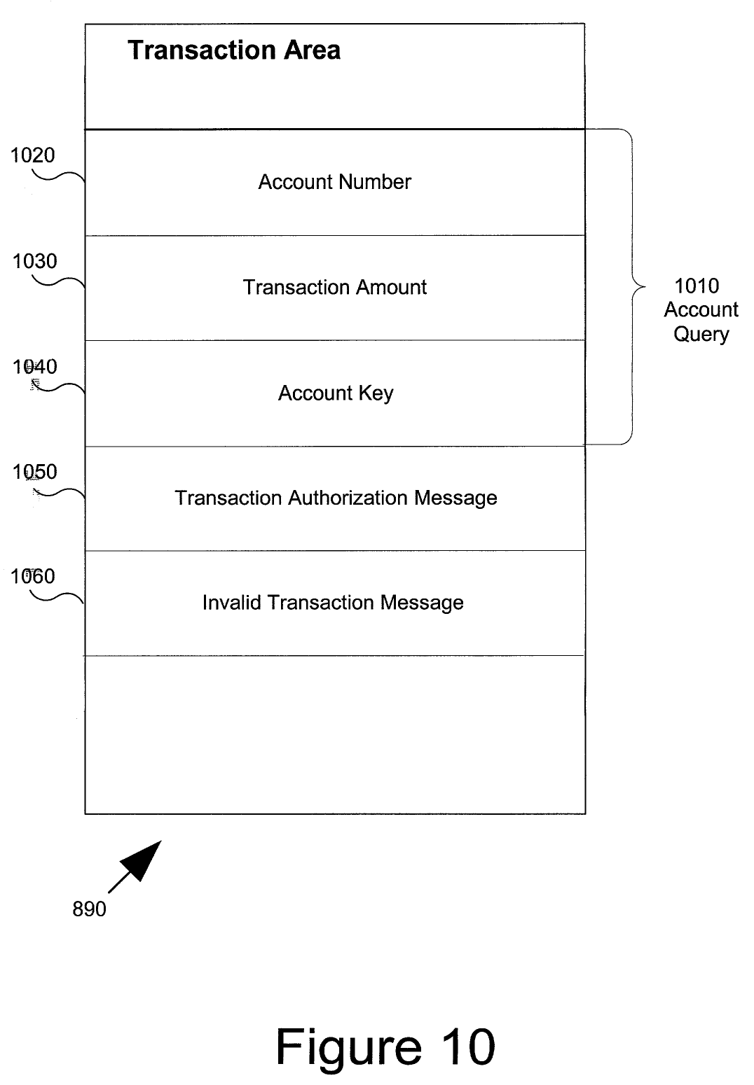

FIG. 10 is a block diagram of one embodiment for transaction area 890. Referring to FIG. 10, transaction area 890 includes account query 1010, transaction authorization message 1050, and invalid transaction message 1060. Account query 1010, in one embodiment, includes account number 1020, transaction amount 1030, and account key 1040. Account key 1040 may be an encrypted key used to verify the account number by the financial processor 140. In one embodiment, account key 1040 is set-up by the user when PTD 100 is registered with the appropriate enabling authority. In one embodiment, account query 1010 is encrypted using well-know encryption technology such as, for example, PKI encryption. Transaction amount 1030 is transaction amount 530 for the financial transaction. Account number 1020 is the identifier of the account selected to conduct the financial transaction.

Transaction authorization message 1050 is an indicator that allows the financial transaction to be completed. In one embodiment, transaction authorization message 1050 allows the user to pay a toll at a tollbooth or similar transaction. Transaction authorization message 1050 does not include any financial processor or user information. Transaction authorization message 1050 only includes an authorization to proceed with the financial transaction. Thus, transaction authorization message 1050 does not contain information as to who the user is, who the financial processor 140 is, or the account being used. Thus the privacy of both the user and the financial processor is maintained.

If the transaction is not valid or the financial processor 140 does not authorize the account for use, invalid transaction message 1060 is transmitted from clearing house 130 to VAPGT 120. In an alternate embodiment, transaction authorization message 1050 and invalid transaction message 1060 may be the same and operate as a flag to indicate if the transaction is authorized or not.

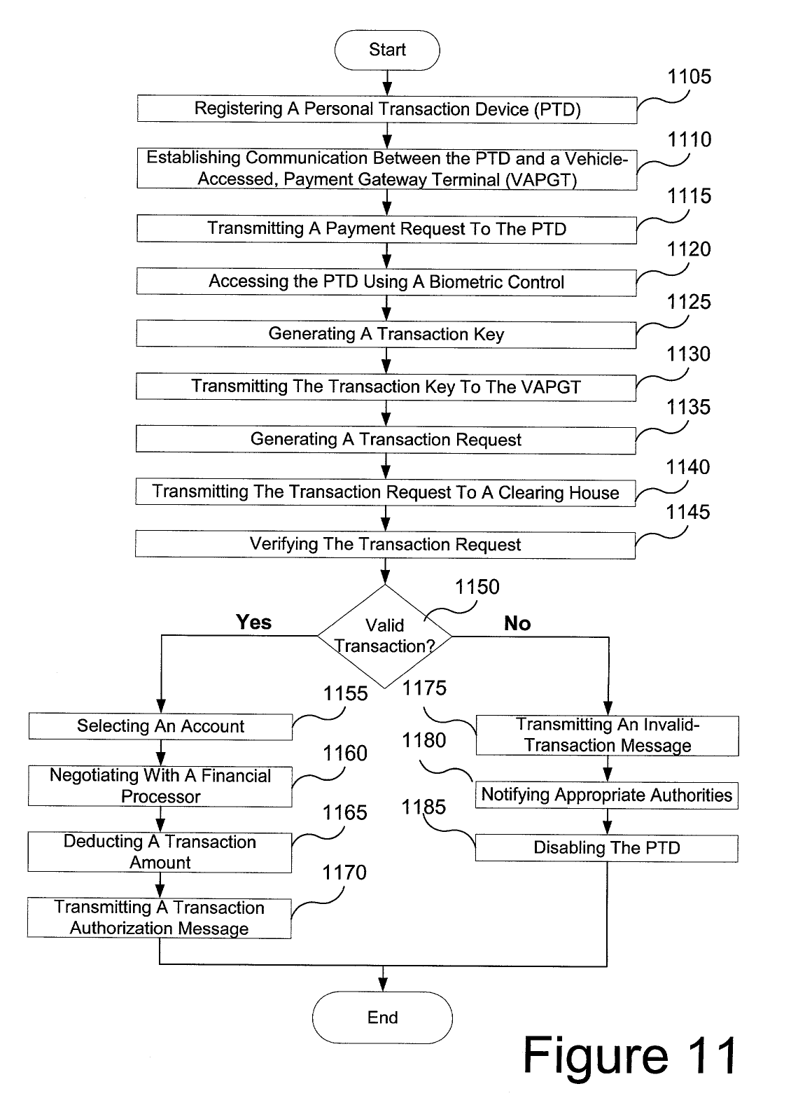

FIG. 11 is a flow diagram for one embodiment of a method for conducting a financial transaction. At processing block 1105, a PTD 100 is registered with an appropriate enabling authority. The appropriate enabling authority may be, for example, a financial institution, a third party distributor, a credit card issuer, or the like. In one embodiment, PTD 100 is associated with a particular user such that only the particular user may access PTD 100 and conduct the financial transaction using PTD 100. Alternatively, a number of users may use PTD 100, each user having a unique biometric key 350 associated with the user and PTD 100.

At processing block 1110, communication is established between PTD 100 and VAPGT 120. As PTD 100 nears VAPGT 120, the proximity of PTD 100 to VAPGT 120 is recognized. In one embodiment, VAPGT 120 may sense the proximity of PTD 100 and initiate communication with the PTD 100. In an alternate embodiment, PTD 100 may sense the proximity of VAPGT 120 and initiate communication with VAPGT 120. Any of a variety of well-known methods for sensing the proximity of the two devices may be used. For example, VAPGT 120 may periodically poll the surrounding area to determine the proximity of a PTD 100.

At processing block 1115, payment request 510 is transmitted to PTD 100. In one embodiment, payment request 510 may include a transaction type, a financial transaction amount, and a VAPGT identifier. Alternatively, any suitable information may be included in payment request 510.

At processing block 1120, PTD 100 is accessed using privacy card 110. In an alternate embodiment, a user may access privacy card 110 prior to the initiation of the financial transaction. For example, the user may access privacy card 110 to enter a vehicle or to start the vehicle. In one embodiment, privacy card 110 is a biometric control. In one embodiment, the user accesses privacy card 110 using a finger or thumbprint input. Alternatively, any means of biometric access may be used. Privacy card 110 uses the biometric input to verify the user of the device. Only a registered user may access PTD 100 via privacy card 110. In one embodiment, if the biometric input is valid for the device, privacy card 110 creates biometric key 350 and transmits biometric key 350 to PTD 100. If privacy card 110 is within PTD 100, validation of the biometric information may be conducted by PTD 100. Alternatively, if privacy card 110 is separate from PTD 100, validation is conducted by privacy card 110. Privacy card 110 only transmits biometric key 350. The biometric information identifying the user is not transmitted at any time. Biometric key 350 is used to unlock PTD 100 and to gain authorization of the financial transaction. In one embodiment, biometric key 350 is encrypted using well-known encryption technology such as, for example, PKI encryption.

At processing block 1125, transaction key 340 is generated if biometric key 350 is valid. In one embodiment, transaction key 340 may include biometric key 350 and a PTD identifier. The PTD identifier identifies the particular PTD being used. In an alternate embodiment, transaction key 340 includes only biometric key 350.

At processing block 1130, transaction key 340 is transmitted to VAPGT 120. Alternatively, transaction key 340 may be transmitted directly to clearing house 130. No user information is transmitted to VAPGT 120. In one embodiment, transaction key 340 is encrypted prior to transmission using well-known encrypting methods such as, for example, public key infrastructure (PKI) encryption.

At processing block 1135, transaction request 520 is generated. In one embodiment, the transaction request includes VAPGT transaction key 560, transaction amount 530, transaction type 540, and terminal identifier 550. Terminal identifier 550 identifies a particular VAPGT 120. In alternate embodiments, transaction request 520 may include other information. In an alternate embodiment, terminal identifier 550 may be generated by PTD 100.

At processing block 1140, transaction request 520 is transmitted to clearing house 130. In one embodiment, transaction request 520 may be encrypted prior to transmission using well-known encrypting methods such as, for example, PKI encryption.

At processing block 1145, transaction request 520 is verified. In one embodiment, transaction request 520 and, if required, transaction key 340, are decrypted. In one embodiment, transaction type 540 is compared with historical transaction events 940 conducted by the user. In addition, transaction request 520 may be compared against pre-established user certificates and profiles 950. In an alternate embodiment, transaction request 520 may be compared against fraud detection systems. Any of a variety of well-known fraud detection systems may be used. Any or all of the above verifications may be performed. In addition, transaction key 340 may be validated against pre-existing user keys 920. In one embodiment, the user may set-up specific keys to conduct specific financial transactions. For example, the user may set up a specific key for conducting tollbooth financial transactions. In an alternate embodiment, one transaction key may be used for all vehicle-accessed financial transactions. In one embodiment, transaction key 340 may be compared against a list of keys 920 associated with the particular user. If a match is found, then transaction key 340 is valid. In addition, biometric key 350 may be compared to pre-established biometric key 950.

At processing block 1150, if transaction request 520 is valid, processing continues at processing block 1155. If transaction request 520 is invalid, processing continues at processing block 1175.

At processing block 1155, if transaction request 520 is valid, a pre-existing account is selected from a number of user accounts associated with PTD 100 to process the financial transaction. In one embodiment, the list of accounts may be maintained on clearing house 130. In one embodiment, an account is selected that is associated with transaction key 340 from user account information 910.

At processing block 1160, negotiation with financial processor 140 is conducted to authorize the financial transaction. Account query 1010 is generated to be transmitted to financial processor 140. In one embodiment, account query 1010 may include account number 1020, transaction amount 1030, and account key 1040. Account key 1040 may be an encrypted key used to verify account number 1020 by the financial processor 140. In one embodiment, account key 1040 is set-up by the user when PTD 100 is registered with the appropriate enabling authority. In one embodiment, account query 1010 is encrypted prior to transmission using well-known encryption technology such as, for example, PKI encryption. In one embodiment, the selected account is specific to financial processor 140.

At processing block 1165, transaction amount 1030 is deducted from the selected account. In one embodiment, account number 1020 is verified against account key 1040 and it is determined if sufficient funds exist in the account for the financial transaction. If the account is valid and sufficient funds exist in the account, an account authorization message is created. The account authorization message is transmitted to clearing house 130. If account query 1010 is invalid or if there are insufficient funds in the account, an invalid account message is transmitted to clearing house 130.

In one embodiment, the account authorization message does not contain any account information. Only an authorization to proceed with the financial transaction is transmitted. In an alternate embodiment, the account information may be contained entirely within clearing house 130 and all account authorization may be conducted from within clearing house 130.

In one embodiment, if the transaction is authorized by financial processor 140, transaction amount 1030 is credited to an account for VAPGT 120. In one embodiment, clearing house 130 negotiates with a financial processor 140 associated with VAPGT 120 to credit an account for the financial transaction. In an alternate embodiment, VAPGT 120 negotiates to credit the appropriate account.

At processing block 1170, if the account is authorized, transaction authorization message 1050 is transmitted to VAPGT 120. Transaction authorization message 1050 allows the financial transaction to be completed. Once transaction authorization message 1050 is received by VAPGT 120, the transaction is completed and processing ends.

In one embodiment, transaction authorization message 1050 allows the user to pay a toll at a tollbooth or similar transaction. Transaction authorization message 1050 does not include any financial processor 140 or user information. Only an authorization to proceed with the financial transaction is transmitted from clearing house 130 to VAPGT 120. Thus, VAPGT 120 does not obtain information as to who the user is, who the financial processor 140 is, or the account being used. Thus the privacy of both the user and the financial processor is maintained.

If at processing block 1150 if transaction request 520 is invalid, processing continues at block 1175. At processing block 1175, an invalid transaction message 1060 is transmitted to VAPGT 120.

At processing block 1180, appropriate policing authorities are notified of the invalid transaction. Appropriate policing authorities may include, for example, a local Police Department, the FBI, the appropriate enabling authority, or the like. One, all, or a combination of many appropriate policing authorities may be contacted. In one embodiment, PTD 100 notifies the appropriate policing authorities. In an alternate embodiment, VAPGT 120 notifies the appropriate policing authorities. In yet another alternate embodiment, clearing house 130 notifies the appropriate policing authorities.

At processing block 1185, PTD 100 is disabled. If invalid transaction message 1060 is transmitted, PTD 100 is disabled. PTD 100 is disabled such that the user may not access PTD 100. Alternatively, PTD 100 may be disabled such that no user may access PTD 100. In one embodiment, the appropriate enabling authority is notified that PTD 100 has been disabled.

In one embodiment, if the account contain insufficient funds, an insufficient funds authorization message is transmitted to VAPGT 120. In this embodiment, the user may be notified of the insufficient funds on display 270. The user may be offered the opportunity to choose a different account to conduct the financial transaction. In this embodiment, the user may select a different account from a list of accounts displayed or enter an account number into I/O 260. Alternatively, the user may pay the financial transaction amount by any other appropriate means such as, for example, cash, credit card, or the like.

In an alternate embodiment, a stand-in processor may be locally connected to VAPGT 120 to verify transaction request 520 and authorize the financial transaction. In this alternate embodiment, the stand-in processor allows the authorization of financial transactions up to a pre-determined value (“floor limits”). Alternatively, the stand-in processor may be local to the vehicle (for example, in the case of a rental car). The authorization occurs locally to VAPGT 120 and does not require the interaction of clearing house 130 to authorize the financial transaction. Transaction request 520 is received from VAPGT 120 and the stand-in processor validates the transaction type and the transaction key as described above in reference to processing blocks 1140, 1145, and 1150. The stand-in processor sends the transaction authorization message or invalid transaction message to VAPGT 120 as described above in reference to processing blocks 1170 and 1175. In this embodiment, the stand-in processor may notify appropriate policing authorities and disable PTD 100 as described above in reference to processing blocks 1180 and 1185. In addition, the stand-in processor sends a message to clearing house 130 to settle the account.

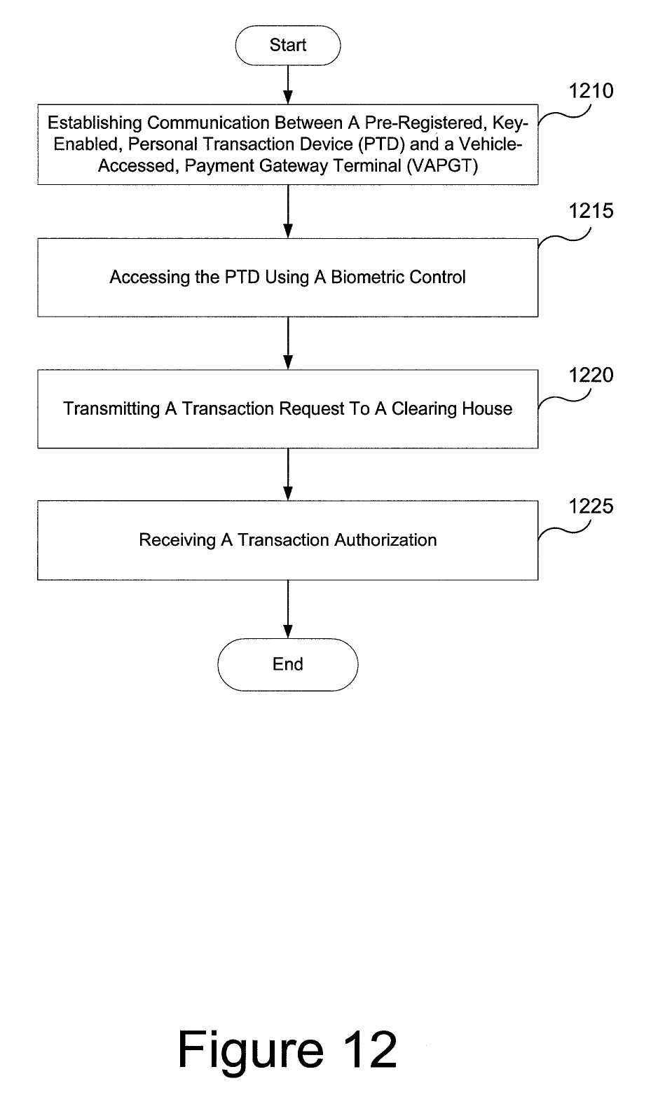

FIG. 12 is a flow diagram for a second embodiment of a method for conducting a financial transaction by a personal transaction device. At processing block 1210, communication is established between PTD 100 and VAPGT 120. As PTD 100 nears VAPGT 120, the proximity of PTD 100 to VAPGT 120 is recognized. In one embodiment, VAPGT 120 may sense the proximity of PTD 100 and initiate communication with the PTD 100. In an alternate embodiment, PTD 100 may sense the proximity of VAPGT 120 and initiate communication with VAPGT 120. Any of a variety of well-known methods for sensing the proximity of the two devices may be used. For example, VAPGT 120 may periodically poll the surrounding area to determine the proximity of a PTD 100.

PTD 100 is pre-registered with an appropriate enabling authority. The appropriate enabling authority may be, for example, a financial institution, a third party distributor, a credit card issuer, or the like. In one embodiment, PTD 100 is associated with a particular user such that only the particular user may access PTD 100 and conduct the financial transaction using PTD 100. Alternatively, a number of users may use PTD 100, each user having a unique biometric key 350 associated with the user and PTD 100.

At processing block 1215, PTD 100 is accessed using privacy card 110 after receiving a payment request 510 from VAPGT 120. In an alternate embodiment, a user may access privacy card 110 prior to the initiation of the financial transaction. For example, the user may access privacy card 110 to enter a vehicle or to start the vehicle. In one embodiment, privacy card 110 is a biometric control. In one embodiment, the user accesses privacy card 110 using a finger or thumbprint input. Alternatively, any means of biometric access may be used. Privacy card 110 uses the biometric input to verify the user of the device. Only a registered user may access PTD 100 via privacy card 110. In one embodiment, if the biometric input is valid for the device, privacy card 110 creates biometric key 350 and transmits biometric key 350 to PTD 100. If privacy card 110 is within PTD 100, validation of the biometric information may be conducted by PTD 100. Alternatively, if privacy card 110 is separate from PTD 100, validation is conducted by privacy card 110. Privacy card 110 only transmits biometric key 350. The biometric information identifying the user is not transmitted at any time. Biometric key 350 is used to unlock PTD 100 and to gain authorization of the financial transaction. In one embodiment, biometric key 350 is encrypted using well-known encryption technology such as, for example, PKI encryption.

Transaction key 340 is generated if biometric key 350 is valid. In one embodiment, transaction key 340 may include biometric key 350 and a PTD identifier. The PTD identifier identifies the particular PTD being used. In an alternate embodiment, transaction key 340 includes only biometric key 350.

Transaction key 340 is transmitted to VAPGT 120. Alternatively, transaction key 340 may be transmitted directly to clearing house 130. No user information is transmitted to VAPGT 120. In one embodiment, transaction key 340 is encrypted prior to transmission using well-known encrypting methods such as, for example, public key infrastructure (PKI) encryption.

Transaction request 520 is generated. In one embodiment, the transaction request includes VAPGT transaction key 560, transaction amount 530, transaction type 540, and terminal identifier 550. Terminal identifier 550 identifies a particular VAPGT 120. In alternate embodiments, transaction request 520 may include other information.

At processing block 1220, transaction request 520 is transmitted to clearing house 130. Transaction request 520 is verified. If transaction request 520 is valid, a pre-existing account is selected from a number of user accounts associated with PTD 100 to process the financial transaction. In one embodiment, an account is selected that is associated with transaction key 340 from user account information 910.

Negotiation with financial processor 140 is conducted to authorize the financial transaction. Account query 1010 is generated to be transmitted to financial processor 140. In one embodiment, account query 1010 is encrypted prior to transmission using well-known encryption technology such as, for example, PKI encryption. In one embodiment, the selected account is specific to financial processor 140.

Transaction amount 1030 is deducted from the selected account. In one embodiment, account number 1020 is verified against account key 1040 and it is determined if sufficient funds exist in the account for the financial transaction. If the account is valid and sufficient funds exist in the account, an account authorization message is created. The account authorization message is transmitted to clearing house 130. If account query 1010 is invalid or if there are insufficient funds in the account, an invalid account message is transmitted to clearing house 130.

In one embodiment, if the transaction is authorized by financial processor 140, transaction amount 1030 is credited to an account for VAPGT 120. In one embodiment, clearing house 130 negotiates with a financial processor 140 associated with VAPGT 120 to credit an account for the financial transaction. In an alternate embodiment, VAPGT 120 negotiates to credit the appropriate account.

At processing block 1225, if the account is authorized, transaction authorization message 1050 is transmitted to VAPGT 120. Once transaction authorization message 1050 is received by VAPGT 120, the transaction is completed and processing ends.

In one embodiment, transaction authorization message 1050 allows the user to pay a toll at a tollbooth or similar transaction. Transaction authorization message 1050 does not include any financial processor 140 or user information. Only an authorization to proceed with the financial transaction is transmitted from clearing house 130 to VAPGT 120. Thus, VAPGT 120 does not obtain information as to who the user is, who the financial processor 140 is, or the account being used. Thus the privacy of both the user and the financial processor is maintained.

If transaction request 520 is invalid, an invalid transaction message 1060 is transmitted to VAPGT 120. Appropriate policing authorities are notified of the invalid transaction. Appropriate policing authorities may include, for example, a local Police Department, the FBI, the appropriate enabling authority, or the like. One, all, or a combination of many appropriate policing authorities may be contacted. In one embodiment, PTD 100 notifies the appropriate policing authorities. In an alternate embodiment, VAPGT 120 notifies the appropriate policing authorities. In yet another alternate embodiment, clearing house 130 notifies the appropriate policing authorities.

PTD 100 is disabled. If invalid transaction message 1060 is transmitted, PTD is disabled. PTD 100 is disabled such that the user may not access PTD 100. Alternatively, PTD 100 may be disabled such that no user may access PTD 100. In one embodiment, the appropriate enabling authority is notified that PTD 100 has been disabled.

In one embodiment, if the account contains insufficient funds, an insufficient funds authorization message is transmitted to VAPGT 120. In this embodiment, the user may be notified of the insufficient funds on display 270. The user may be offered the opportunity to choose a different account to conduct the financial transaction. In this embodiment, the user may select a different account from a list of accounts displayed or enter an account number into I/O 260. Alternatively, the user may pay the financial transaction amount by any other appropriate means such as, for example, cash, credit card, or the like.

In an alternate embodiment, a stand-in processor may be locally connected to VAPGT 120 to verify transaction request 520 and authorize the financial transaction. In this alternate embodiment, the stand-in processor allows the authorization of financial transactions up to a pre-determined value (“floor limits”). Alternatively, the stand-in processor may be local to the vehicle (for example, in the case of a rental car). The authorization occurs locally to VAPGT 120 and does not require the interaction of clearing house 130 to authorize the financial transaction. Transaction request 520 is received from VAPGT 120 and the stand-in processor validates the transaction type and the transaction key as described above in reference to processing block 1220. The stand-in processor sends the transaction authorization message or invalid transaction message to VAPGT 120 as described above in reference to processing block 1225. In this embodiment, the stand-in processor may notify appropriate policing authorities and disable PTD 100 as described above. In addition, the stand-in processor sends a message to clearing house 130 to settle the account.

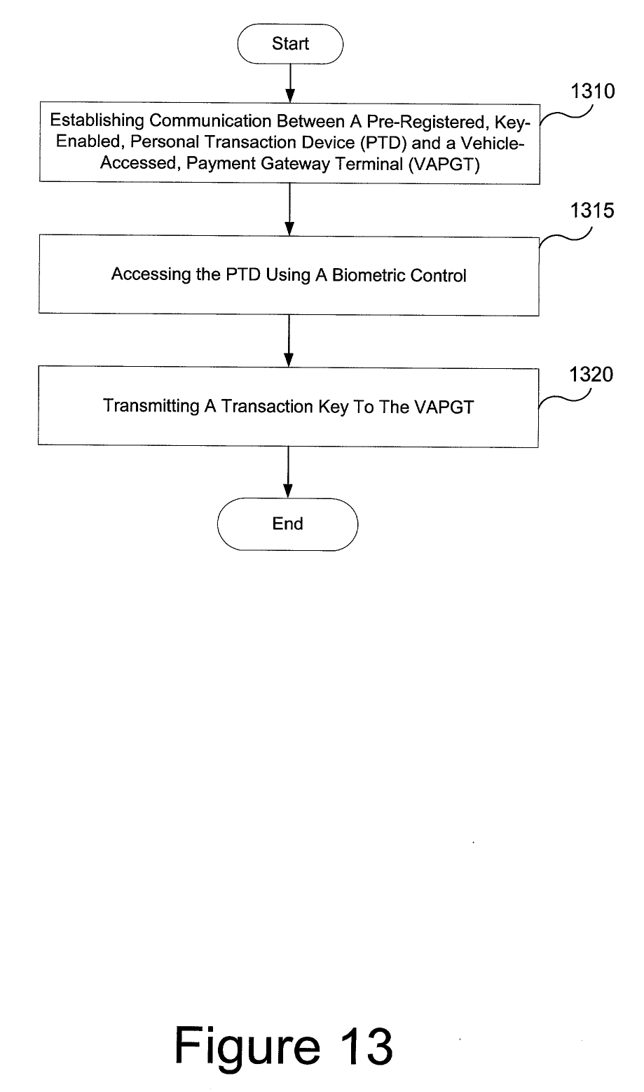

FIG. 13 is a flow diagram for one embodiment of a method for conducting a financial transaction by a PTD 100. At processing block 1310, communication is established between PTD 100 and VAPGT 120. As PTD 100 nears VAPGT 120, the proximity of PTD 100 to VAPGT 120 is recognized. In one embodiment, VAPGT 120 may sense the proximity of PTD 100 and initiate communication with the PTD 100. In an alternate embodiment, PTD 100 may sense the proximity of VAPGT 120 and initiate communication with VAPGT 120. Any of a variety of well-known methods for sensing the proximity of the two devices may be used. For example, VAPGT 120 may periodically poll the surrounding area to determine the proximity of a PTD 100.

At processing block 1315, PTD 100 is accessed using privacy card 110 after PTD 100 receives a payment request 510. In an alternate embodiment, a user may access privacy card 110 prior to the initiation of the financial transaction. For example, the user may access privacy card 110 to enter a vehicle or to start the vehicle. In one embodiment, privacy card 110 is a biometric control. In one embodiment, the user accesses privacy card 110 using a finger or thumbprint input. Alternatively, any means of biometric access may be used. Privacy card 110 uses the biometric input to verify the user of the device. Only a registered user may access PTD 100 via privacy card 110. In one embodiment, if the biometric input is valid for the device, privacy card 110 creates biometric key 350 and transmits biometric key 350 to PTD 100. If privacy card 110 is within PTD 100, validation of the biometric information may be conducted by PTD 100. Alternatively, if privacy card 110 is separate from PTD 100, validation is conducted by privacy card 110. Privacy card 110 only transmits biometric key 350. The biometric information identifying the user is not transmitted at any time. Biometric key 350 is used to unlock PTD 100 and to gain authorization of the financial transaction. In one embodiment, biometric key 350 is encrypted using well-known encryption technology such as, for example, PKI encryption.

At processing block 1320, transaction key 340 is generated if biometric key 350 is valid. In one embodiment, transaction key 340 may include biometric key 350 and a PTD identifier. The PTD identifier identifies the particular PTD being used. In an alternate embodiment, transaction key 340 includes only biometric key 350.

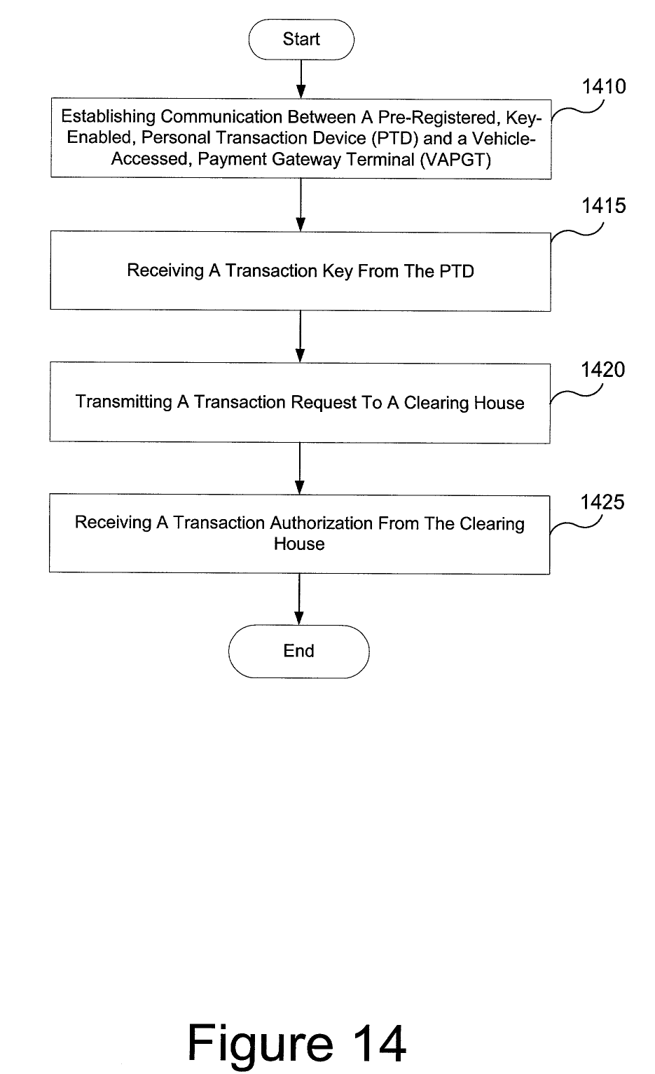

FIG. 14 is a flow diagram for one embodiment of a method for conducting a financial transaction by a vehicle-accessed, payment gateway terminal (VAPGT) 120. At processing block 1410, communication is established between PTD 100 and VAPGT 120. As PTD 100 nears VAPGT 120, the proximity of PTD 100 to VAPGT 120 is recognized. In one embodiment, VAPGT 120 may sense the proximity of PTD 100 and initiate communication with the PTD 100. In an alternate embodiment, PTD 100 may sense the proximity of VAPGT 120 and initiate communication with VAPGT 120. Any of a variety of well-known methods for sensing the proximity of the two devices may be used. For example, VAPGT 120 may periodically poll the surrounding area to determine the proximity of a PTD 100.

Payment request 510 is transmitted to PTD 100. In one embodiment, payment request 510 may include a transaction type, a financial transaction amount, and a VAPGT identifier. Alternatively, any suitable information may be included in payment request 510.

At processing block 1415, transaction key 340 is received from PTD 100. No user information is transmitted to VAPGT 120. Transaction request 520 is generated. In one embodiment, the transaction request includes VAPGT transaction key 560, transaction amount 530, transaction type 540, and terminal identifier 550. Terminal identifier 550 identifies a particular VAPGT 120. In alternate embodiments, transaction request 520 may include other information.

At processing block 1420, transaction request 520 is transmitted to clearing house 130. In one embodiment, transaction request 520 may be encrypted prior to transmission using well-known encrypting methods such as, for example, PKI encryption.

At processing block 1425, if the account is authorized, transaction authorization message 1050 is received. Transaction authorization message 1050 allows the financial transaction to be completed. Once transaction authorization message 1050 is received by VAPGT 120, the transaction is completed and processing ends.

In one embodiment, transaction authorization message 1050 allows the user to pay a toll at a tollbooth or similar transaction. Transaction authorization message 1050 does not include any financial processor 140 or user information. Only an authorization to proceed with the financial transaction is transmitted from clearing house 130 to VAPGT 120. Thus, VAPGT 120 does not obtain information as to who the user is, who the financial processor 140 is, or the account being used. Thus the privacy of both the user and the financial processor is maintained.

If transaction request 520 is invalid, an invalid transaction message 1060 is received. Appropriate policing authorities are notified of the invalid transaction. Appropriate policing authorities may include, for example, a local Police Department, the FBI, the appropriate enabling authority, or the like. One, all, or a combination of many appropriate policing authorities may be contacted.

In an alternate embodiment, a stand-in processor may be locally connected to VAPGT 120 to verify transaction request 520 and authorize the financial transaction. In this alternate embodiment, the stand-in processor allows the authorization of financial transactions up to a pre-determined value (“floor limits”). Alternatively, the stand-in processor may be local to the vehicle (for example, in the case of a rental car). The authorization occurs locally to VAPGT 120 and does not require the interaction of clearing house 130 to authorize the financial transaction. Transaction request 520 is received from VAPGT 120 and the stand-in processor validates the transaction type and the transaction key as described above in reference to processing block 1415. The stand-in processor sends the transaction authorization message or invalid transaction message to VAPGT 120 as described above in reference to processing block 1425. In this embodiment, the stand-in processor may notify appropriate policing authorities and disable PTD 100 as described above. In addition, the stand-in processor sends a message to clearing house 130 to settle the account.

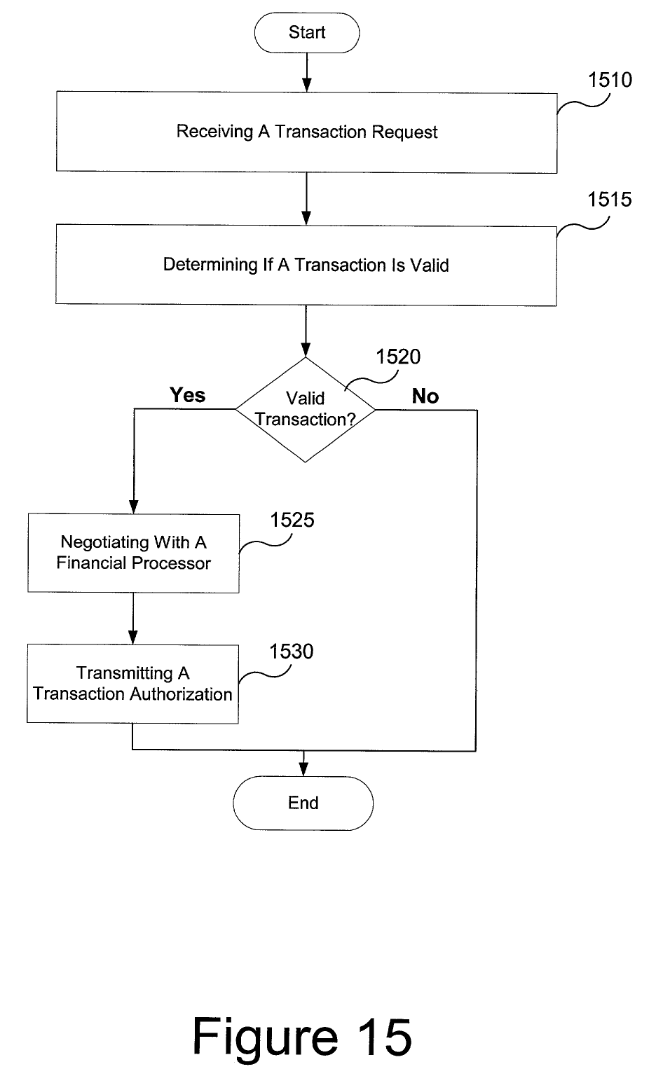

FIG. 15 is a flow diagram for one embodiment of a method for conducting a financial transaction by clearing house 130. At processing block 1510, transaction request 520 is received. In one embodiment, transaction request 520 may be encrypted prior to transmission using well-known encrypting methods such as, for example, PKI encryption.

At processing block 1515, transaction request 520 is verified. In one embodiment, transaction request 520 and, if required, transaction key 340, are decrypted. In one embodiment, transaction type 540 is compared with historical transaction events 940 conducted by the user. In addition, transaction request 520 may be compared against pre-established user certificates and profiles 950. In an alternate embodiment, transaction request 520 may be compared against fraud detection systems. Any of a variety of well-known fraud detection systems may be used. Any or all of the above verifications may be performed. In addition, transaction key 340 may be validated against pre-existing user keys 920. In one embodiment, the user may set-up specific keys to conduct specific financial transactions. For example, the user may set up a specific key for conducting tollbooth financial transactions. In an alternate embodiment, one transaction key may be used for all vehicle-accessed financial transactions. In one embodiment, transaction key 340 may be compared against a list of keys 920 associated with the particular user. If a match is found, then transaction key 340 is valid. In addition, biometric key 350 may be compared to pre-established biometric key 950.

At processing block 1520, if transaction request 520 is valid, processing continues at processing block 1525. If transaction request 520 is invalid, processing ends.

At processing block 1525, if transaction request 520 is valid, a pre-existing account is selected from a number of user accounts associated with PTD 100 to process the financial transaction. In one embodiment, the list of accounts may be maintained on clearing house 130. In one embodiment, an account is selected that is associated with transaction key 340 from user account information 910.

Negotiation with financial processor 140 is conducted to authorize the financial transaction. Account query 1010 is generated to be transmitted to financial processor 140. In one embodiment, account query 1010 may include account number 1020, transaction amount 1030, and account key 1040. Account key 1040 may be an encrypted key used to verify account number 1020 by the financial processor 140. In one embodiment, account key 1040 is set-up by the user when PTD 100 is registered with the appropriate enabling authority. In one embodiment, account query 1010 is encrypted prior to transmission using well-known encryption technology such as, for example, PKI encryption. In one embodiment, the selected account is specific to financial processor 140.

Transaction amount 1030 is deducted from the selected account. In one embodiment, account number 1020 is verified against account key 1040 and it is determined if sufficient funds exist in the account for the financial transaction. If the account is valid and sufficient funds exist in the account, an account authorization message is created. The account authorization message is transmitted to clearing house 130. If account query 1010 is invalid or if there are insufficient funds in the account, an invalid account message is transmitted to clearing house 130.

In one embodiment, the account authorization message does not contain any account information. Only an authorization to proceed with the financial transaction is transmitted. In an alternate embodiment, the account information may be contained entirely within clearing house 130 and all account authorization may be conducted from within clearing house 130.

In one embodiment, if the transaction is authorized by financial processor 140, transaction amount 1030 is credited to an account for VAPGT 120. In one embodiment, clearing house 130 negotiates with a financial processor 140 associated with VAPGT 120 to credit an account for the financial transaction. In an alternate embodiment, VAPGT 120 negotiates to credit the appropriate account.

At processing block 1530, if the account is authorized, transaction authorization message 1050 is transmitted to VAPGT 120. Transaction authorization message 1050 allows the financial transaction to be completed.

In one embodiment, transaction authorization message 1050 allows the user to pay a toll at a tollbooth or similar transaction. Transaction authorization message 1050 does not include any financial processor 140 or user information. Only an authorization to proceed with the financial transaction is transmitted from clearing house 130 to VAPGT 120. Thus, VAPGT 120 does not obtain information as to who the user is, who the financial processor 140 is, or the account being used. Thus the privacy of both the user and the financial processor is maintained.

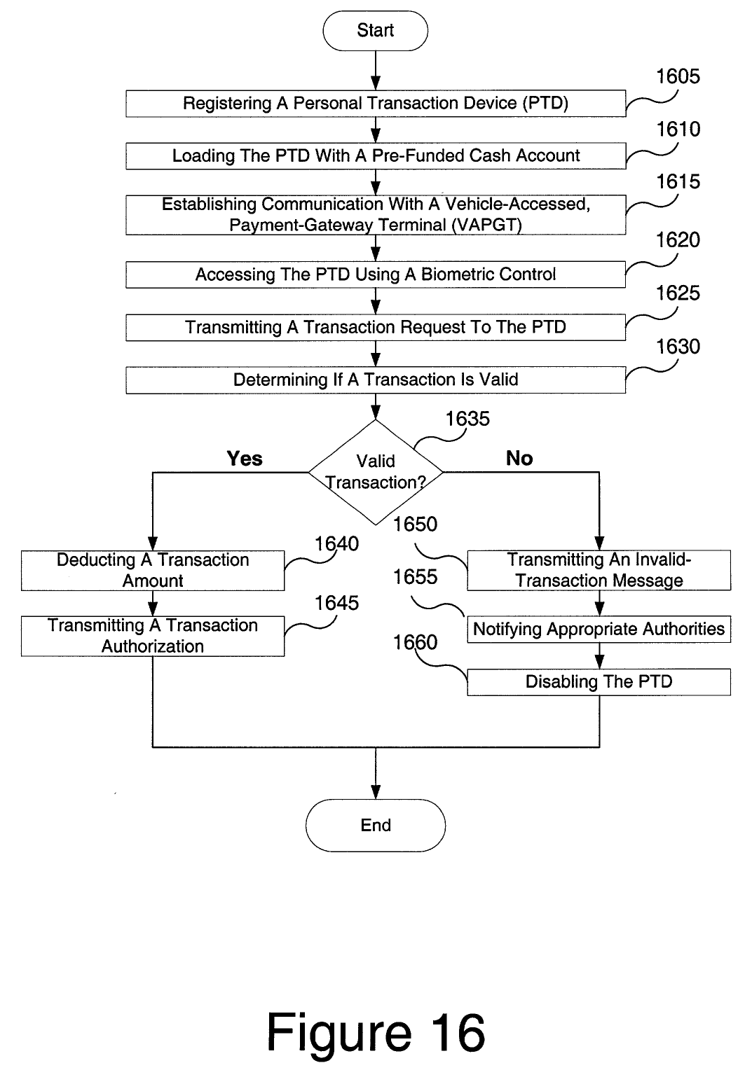

FIG. 16 is a flow diagram for a third embodiment of a method for conducting a financial transaction. At processing block 1605, a PTD 100 is registered with an appropriate enabling authority. The appropriate enabling authority may be, for example, a financial institution, a third party distributor, a credit card issuer, or the like. In one embodiment, PTD 100 is associated with a particular user such that only the particular user may access PTD 100 and conduct the financial transaction using PTD 100. Alternatively, a number of users may use PTD 100, each user having a unique biometric key 350 associated with the user and PTD 100.

At processing block 1610, PTD 100 is loaded with a pre-funded cash account. A user negotiates with an appropriate authority to load the pre-funded cash account. The appropriate authority may be, for example, a bank, financial institution, or a public authority such as a store or kiosk. The pre-funded cash account is loaded with a fixed amount of appropriate currency to conduct financial transactions.

At processing block 1615, communication is established between PTD 100 and VAPGT 120. As PTD 100 nears VAPGT 120, the proximity of PTD 100 to VAPGT 120 is recognized. In one embodiment, VAPGT 120 may sense the proximity of PTD 100 and initiate communication with the PTD 100. In an alternate embodiment, PTD 100 may sense the proximity of VAPGT 120 and initiate communication with VAPGT 120. Any of a variety of well-known methods for sensing the proximity of the two devices may be used. For example, VAPGT 120 may periodically poll the surrounding area to determine the proximity of a PTD 100.

Payment request 510 is transmitted to PTD 100. In one embodiment, payment request 510 may include a transaction type, a financial transaction amount, and a VAPGT identifier. Alternatively, any suitable information may be included in payment request 510.

At processing block 1620, PTD 100 is accessed using privacy card 110. In an alternate embodiment, a user may access privacy card 110 prior to the initiation of the financial transaction. For example, the user may access privacy card 110 to enter a vehicle or to start the vehicle. In one embodiment, privacy card 110 is a biometric control. In one embodiment, the user accesses privacy card 110 using a finger or thumbprint input. Alternatively, any means of biometric access may be used. Privacy card 110 uses the biometric input to verify the user of the device. Only a registered user may access PTD 100 via privacy card 110. In one embodiment, if the biometric input is valid for the device, privacy card 110 creates biometric key 350 and transmits biometric key 350 to PTD 100. If privacy card 110 is within PTD 100, validation of the biometric information may be conducted by PTD 100. Alternatively, if privacy card 110 is separate from PTD 100, validation is conducted by privacy card 110. Privacy card 110 only transmits biometric key 350. The biometric information identifying the user is not transmitted at any time. Biometric key 350 is used to unlock PTD 100 and to gain authorization of the financial transaction. In one embodiment, biometric key 350 is encrypted using well-known encryption technology such as, for example, PKI encryption.

Transaction key 340 is generated if biometric key 350 is valid. In one embodiment, transaction key 340 may include biometric key 350 and a PTD identifier. The PTD identifier identifies the particular PTD being used. In an alternate embodiment, transaction key 340 includes only biometric key 350.

At processing block 1625, transaction key 340 is transmitted to VAPGT 120. No user information is transmitted to VAPGT 120. In one embodiment, transaction key 340 is encrypted prior to transmission using well-known encrypting methods such as, for example, public key infrastructure (PKI) encryption.

At processing block 1625, transaction request 520 is transmitted to PTD 100. VAPGT 120 generates transaction request 520 prior to transmission. In one embodiment, the transaction request includes VAPGT transaction key 560, transaction amount 530, transaction type 540, and terminal identifier 550. Terminal identifier 550 identifies a particular VAPGT 120. In alternate embodiments, transaction request 520 may include other information. In one embodiment, transaction request 520 may be encrypted prior to transmission using well-known encrypting methods such as, for example, PKI encryption.

At processing block 1630, transaction request 520 is verified. In one embodiment, transaction request 520 and, if required, transaction key 340, are decrypted. In one embodiment, transaction type 540 is compared with historical transaction events conducted by the user. In addition, transaction request 520 may be compared against pre-established user certificates and profiles. In an alternate embodiment, transaction request 520 may be compared against fraud detection systems. Any of a variety of well-known fraud detection systems may be used. Any or all of the above verifications may be performed. In addition, transaction key 340 may be validated against pre-existing user keys. In one embodiment, the user may set-up specific keys to conduct specific financial transactions. For example, the user may set up a specific key for conducting tollbooth financial transactions. In an alternate embodiment, one transaction key may be used for all vehicle-accessed financial transactions. In one embodiment, transaction key 340 may be compared against a list of keys associated with the particular user. If a match is found, then transaction key 340 is valid. In addition, biometric key 350 may be compared to a pre-established biometric key.

At processing block 1635, if transaction request 520 is valid, processing continues at processing block 1640. If transaction request 520 is invalid, processing continues at processing block 1650.

At processing block 1640, if transaction request 520 is valid, the transaction amount is deducted from the pre-funded cash account. If the balance within the pre-funded cash account is insufficient for the financial transaction, in one embodiment, the user is notified that not enough cash remains in the account. In addition, VAPGT 120 is notified that not enough cash is remaining. By notifying the user of the lack of cash within the pre-funded account, the user may pay the transaction amount by any other appropriate means such as, for example, cash, credit card, or the like.

At processing block 1645, an account authorization message is transmitted to VAPGT 120. In one embodiment, the account authorization message does not contain any account information. Only an authorization to proceed with the financial transaction is transmitted. In one embodiment, if the transaction is authorized, transaction amount 1030 is credited to an account for VAPGT 120. In one embodiment, In one embodiment, VAPGT 120 negotiates to credit the appropriate account. Transaction authorization message 1050 allows the financial transaction to be completed. Once transaction authorization message 1050 is received by VAPGT 120, the transaction is completed and processing ends.

In one embodiment, transaction authorization message 1050 allows the user to pay a toll at a tollbooth or similar transaction. Transaction authorization message 1050 does not include any financial processor 140 or user information. Only an authorization to proceed with the financial transaction is transmitted to VAPGT 120. Thus, VAPGT 120 does not obtain information as to who the user is, or the account being used. Thus the privacy of the user is maintained.

If at processing block 1635, if transaction request 520 is invalid, processing continues at block 1650. At processing block 1650, an invalid transaction message 1060 is transmitted to VAPGT 120.

At processing block 1655, appropriate policing authorities are notified of the invalid transaction. Appropriate policing authorities may include, for example, a local Police Department, the FBI, the appropriate enabling authority, or the like. One, all, or a combination of many appropriate policing authorities may be contacted. In one embodiment, PTD 100 notifies the appropriate policing authorities. In an alternate embodiment, VAPGT 120 notifies the appropriate policing authorities.

At processing block 1660, PTD 100 is disabled. If invalid transaction message 1060 is transmitted, PTD is disabled. PTD 100 is disabled such that the user may not access PTD 100. Alternatively, PTD 100 may be disabled such that no user may access PTD 100. In one embodiment, the appropriate enabling authority is notified that PTD 100 has been disabled.

In one embodiment, if the account contain insufficient funds, an insufficient funds authorization message is transmitted to VAPGT 120. In this embodiment, the user may be notified of the insufficient funds on display 270. The user may be offered the opportunity to choose a different account to conduct the financial transaction. In this embodiment, the user may select a different account from a list of accounts displayed or enter an account number into I/O 260. Alternatively, the user may pay the financial transaction amount by any other appropriate means such as, for example, cash, credit card, or the like.

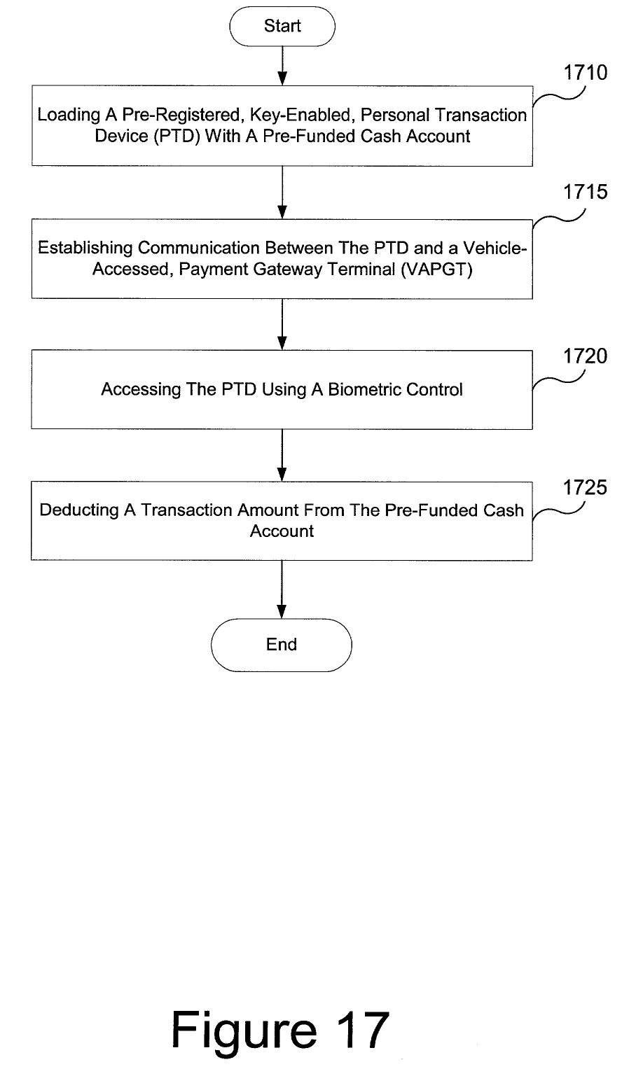

FIG. 17 is a flow diagram for a fourth embodiment of a method for conducting a financial transaction. At processing block 1710, PTD 100 is loaded with a pre-funded cash account. A user negotiates with an appropriate authority to load the pre-funded cash account. The appropriate authority may be, for example, a bank, financial institution, or a public authority such as a store or kiosk. The pre-funded cash account is loaded with a fixed amount of appropriate currency to conduct financial transactions.

At processing block 1715, communication is established between PTD 100 and VAPGT 120. As PTD 100 nears VAPGT 120, the proximity of PTD 100 to VAPGT 120 is recognized. In one embodiment, VAPGT 120 may sense the proximity of PTD 100 and initiate communication with the PTD 100. In an alternate embodiment, PTD 100 may sense the proximity of VAPGT 120 and initiate communication with VAPGT 120. Any of a variety of well-known methods for sensing the proximity of the two devices may be used. For example, VAPGT 120 may periodically poll the surrounding area to determine the proximity of a PTD 100.

Payment request 510 is transmitted to PTD 100. In one embodiment, payment request 510 may include a transaction type, a financial transaction amount, and a VAPGT identifier. Alternatively, any suitable information may be included in payment request 510.

At processing block 1720, PTD 100 is accessed using privacy card 110. In an alternate embodiment, a user may access privacy card 110 prior to the initiation of the financial transaction. For example, the user may access privacy card 110 to enter a vehicle or to start the vehicle. In one embodiment, privacy card 110 is a biometric control. In one embodiment, the user accesses privacy card 110 using a finger or thumbprint input. Alternatively, any means of biometric access may be used. Privacy card 110 uses the biometric input to verify the user of the device. Only a registered user may access PTD 100 via privacy card 110. In one embodiment, if the biometric input is valid for the device, privacy card 110 creates biometric key 350 and transmits biometric key 350 to PTD 100. If privacy card 110 is within PTD 100, validation of the biometric information may be conducted by PTD 100. Alternatively, if privacy card 110 is separate from PTD 100, validation is conducted by privacy card 110. Privacy card 110 only transmits biometric key 350. The biometric information identifying the user is not transmitted at any time. Biometric key 350 is used to unlock PTD 100 and to gain authorization of the financial transaction. In one embodiment, biometric key 350 is encrypted using well-known encryption technology such as, for example, PKI encryption.

Transaction key 340 is generated if biometric key 350 is valid. In one embodiment, transaction key 340 may include biometric key 350 and a PTD identifier. The PTD identifier identifies the particular PTD being used. In an alternate embodiment, transaction key 340 includes only biometric key 350.

Transaction key 340 is transmitted to VAPGT 120. No user information is transmitted to VAPGT 120. In one embodiment, transaction key 340 is encrypted prior to transmission using well-known encrypting methods such as, for example, public key infrastructure (PKI) encryption.

Transaction request 520 is transmitted to PTD 100. VAPGT 120 generates transaction request 520 prior to transmission. In one embodiment, the transaction request includes VAPGT transaction key 560, transaction amount 530, transaction type 540, and terminal identifier 550. Terminal identifier 550 identifies a particular VAPGT 120. In alternate embodiments, transaction request 520 may include other information. In one embodiment, transaction request 520 may be encrypted prior to transmission using well-known encrypting methods such as, for example, PKI encryption.

Transaction request 520 is verified. In one embodiment, transaction request 520 and, if required, transaction key 340, are decrypted. In one embodiment, transaction type 540 is compared with historical transaction events conducted by the user. In addition, transaction request 520 may be compared against pre-established user certificates and profiles. In an alternate embodiment, transaction request 520 may be compared against fraud detection systems. Any of a variety of well-known fraud detection systems may be used. Any or all of the above verifications may be performed. In addition, transaction key 340 may be validated against pre-existing user keys. In one embodiment, the user may set-up specific keys to conduct specific financial transactions. For example, the user may set up a specific key for conducting tollbooth financial transactions. In an alternate embodiment, one transaction key may be used for all vehicle-accessed financial transactions. In one embodiment, transaction key 340 may be compared against a list of keys associated with the particular user. If a match is found, then transaction key 340 is valid. In addition, biometric key 350 may be compared to a pre-established biometric key.

At processing block 1725, if transaction request 520 is valid, the transaction amount is deducted from the pre-funded cash account. If the balance within the pre-funded cash account is insufficient for the financial transaction, in one embodiment, the user is notified that not enough cash remains in the account. In addition, VAPGT 120 is notified that not enough cash is remaining. By notifying the user of the lack of cash within the pre-funded account, the user may pay the transaction amount by any other appropriate means such as, for example, cash, credit card, or the like.

An account authorization message is transmitted to VAPGT 120. In one embodiment, the account authorization message does not contain any account information. Only an authorization to proceed with the financial transaction is transmitted. In one embodiment, if the transaction is authorized, transaction amount 1030 is credited to an account for VAPGT 120. In one embodiment, In one embodiment, VAPGT 120 negotiates to credit the appropriate account. Transaction authorization message 1050 allows the financial transaction to be completed. Once transaction authorization message 1050 is received by VAPGT 120, the transaction is completed and processing ends.

In one embodiment, transaction authorization message 1050 allows the user to pay a toll at a tollbooth or similar transaction. Transaction authorization message 1050 does not include any financial processor 140 or user information. Only an authorization to proceed with the financial transaction is transmitted to VAPGT 120. Thus, VAPGT 120 does not obtain information as to who the user is, or the account being used. Thus the privacy of the user is maintained.

If transaction request 520 is invalid, an invalid transaction message 1060 is transmitted to VAPGT 120.

Appropriate policing authorities are notified of the invalid transaction. Appropriate policing authorities may include, for example, a local Police Department, the FBI, the appropriate enabling authority, or the like. One, all, or a combination of many appropriate policing authorities may be contacted. In one embodiment, PTD 100 notifies the appropriate policing authorities. In an alternate embodiment, VAPGT 120 notifies the appropriate policing authorities.

PTD 100 is disabled. If invalid transaction message 1060 is transmitted, PTD is disabled. PTD 100 is disabled such that the user may not access PTD 100. Alternatively, PTD 100 may be disabled such that no user may access PTD 100. In one embodiment, the appropriate enabling authority is notified that PTD 100 has been disabled.

In one embodiment, if the account contains insufficient funds, an insufficient funds authorization message is transmitted to VAPGT 120. In this embodiment, the user may be notified of the insufficient funds on display 270. The user may be offered the opportunity to choose a different account to conduct the financial transaction. In this embodiment, the user may select a different account from a list of accounts displayed or enter an account number into I/O 260. Alternatively, the user may pay the financial transaction amount by any other appropriate means such as, for example, cash, credit card, or the like.

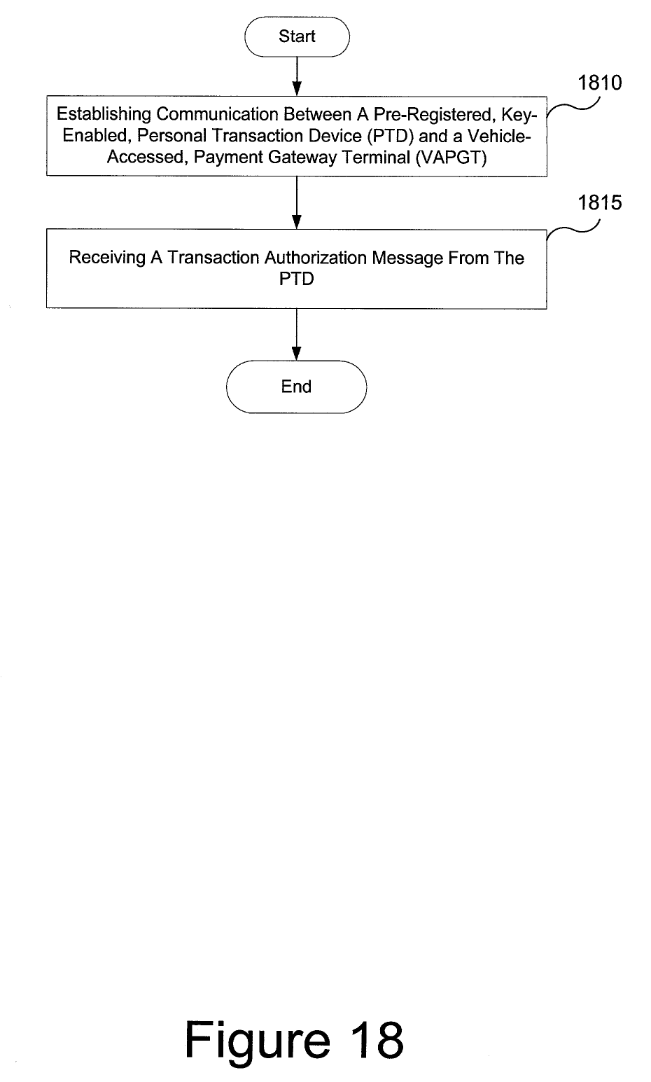

FIG. 18 is a flow diagram for a second embodiment of a method for conducting a financial transaction by a vehicle-accessed, payment gateway terminal (VAPGT) 120. At processing block 1810, communication is established between PTD 100 and VAPGT 120. As PTD 100 nears VAPGT 120, the proximity of PTD 100 to VAPGT 120 is recognized. In one embodiment, VAPGT 120 may sense the proximity of PTD 100 and initiate communication with the PTD 100. In an alternate embodiment, PTD 100 may sense the proximity of VAPGT 120 and initiate communication with VAPGT 120. Any of a variety of well-known methods for sensing the proximity of the two devices may be used. For example, VAPGT 120 may periodically poll the surrounding area to determine the proximity of a PTD 100.

Payment request 510 is transmitted to PTD 100. In one embodiment, payment request 510 may include a transaction type, a financial transaction amount, and a VAPGT identifier. Alternatively, any suitable information may be included in payment request 510.

At processing block 1815, an account authorization message is received. In one embodiment, the account authorization message does not contain any account information. Only an authorization to proceed with the financial transaction is transmitted. In one embodiment, if the transaction is authorized, transaction amount 1030 is credited to an account for VAPGT 120. In one embodiment, In one embodiment, VAPGT 120 negotiates to credit the appropriate account. Transaction authorization message 1050 allows the financial transaction to be completed. Once transaction authorization message 1050 is received by VAPGT 120, the transaction is completed and processing ends.

In one embodiment, transaction authorization message 1050 allows the user to pay a toll at a tollbooth or similar transaction. Transaction authorization message 1050 does not include any financial processor 140 or user information. Only an authorization to proceed with the financial transaction is transmitted to VAPGT 120. Thus, VAPGT 120 does not obtain information as to who the user is, or the account being used. Thus the privacy of the user is maintained.

If transaction request 520 is invalid, an invalid transaction message 1060 is received. Appropriate policing authorities are notified of the invalid transaction. Appropriate policing authorities may include, for example, a local Police Department, the FBI, the appropriate enabling authority, or the like. One, all, or a combination of many appropriate policing authorities may be contacted. In one embodiment, PTD 100 notifies the appropriate policing authorities. In an alternate embodiment, VAPGT 120 notifies the appropriate policing authorities.

The specific arrangements and methods herein are merely illustrative of the principles of this invention. Numerous modifications in form and detail may be made by those skilled in the art without departing from the true spirit and scope of the invention.

What is claimed is:

1. A method for conducting a financial transaction comprising:
establishing communication between a vehicle-accessed, payment-gateway terminal (VAPGT) and a pre-registered, key-enabled, personal transaction device (PTD);
accessing the PTD using a privacy card;
transmitting a transaction request to a server; and
receiving a transaction authorization message from the server to complete the transaction.

2. The method of claim 1 wherein the privacy card is a biometric control device.

3. The method of claim 1 further comprising:
initiating communication with the VAPGT by the PTD.

4. The method of claim 1 further comprising:
initiating communication with the PTD by the VAPGT.

5. The method of claim 1 further comprising:
registering the PTD with an appropriate enabling authority, the PTD is associated with a particular user.

6. The method of claim 5 wherein the appropriate enabling authority is selected from the group consisting of a financial institution, a third-party distributor, and a credit card issuer.

7. The method of claim 1 further comprising:
generating a transaction key; and
transmitting the transaction key to the VAPGT.

8. The method of claim 7 further comprising:
combining the transaction key together with a transaction amount and a VAPGT identifier to generate the transaction request.

9. The method of claim 8 further comprising:
determining if the transaction is valid; and
if the transaction is valid,
selecting a pre-existing account of a plurality of accounts associated with the transaction key,
negotiating with a financial processor to authorize the transaction, and
deducting the transaction amount from the pre-existing account.

10. The method of claim 9 wherein determining if the transaction is valid further comprises:
comparing a current transaction type against historical transaction events and pre-established certificates.

11. The method of claim 10 further comprising:
validating the transaction key against existing user keys.

12. The method of claim 9 wherein determining if the transaction is valid further comprises:
comparing a current transaction type against fraud detection systems.

13. The method of claim 9 further comprising: if the transaction is not valid,
transmitting an invalid transaction message to the VAPGT,
notifying appropriate authorities of the invalid transaction, and disabling the PTD.

14. The method of claim 1 wherein the server is remotely connected to the VAPGT and PTD.

15. The method of claim 1 wherein the PTD and VAPGT communicate via a wireless connection.

16. The method of claim 1 wherein the PTD is a PKI-enabled PTD.

17. The method of claim 1 wherein the VAPGT is selected from the group consisting of a tollbooth, a vehicular kiosk, a ticket booth, and a smog certification station.

18. A method for conducting a financial transaction comprising:
establishing communication between a vehicle-accessed, payment-gateway terminal (VAPGT) and a pre-registered, key-enabled, personal transaction device (PTD);
accessing the PTD using a privacy card; and
transmitting a transaction key to the VAPGT.

19. The method of claim 18 wherein the privacy card is a biometric control device.

20. The method of claim 18 further comprising:
initiating communication with the VAPGT by the PTD.

21. The method of claim 18 further comprising:
initiating communication with the PTD by the VAPGT.

22. The method of claim 18 further comprising:
registering the PTD with an appropriate enabling authority, the PTD is associated with a particular user.

23. The method of claim 22 wherein the appropriate enabling authority is selected from the group consisting of a financial institution, a third-party distributor, and a credit card issuer.

24. The method of claim 18 further comprising:
generating a transaction key.

25. The method of claim 18 further comprising:
receiving an invalid transaction message; and
disabling the PTD.

26. The method of claim 18 wherein the PTD and VAPGT communicate via a wireless connection.

27. The method of claim 18 wherein the PTD is a PKI-enabled PTD.

28. The method of claim 18 wherein the VAPGT is selected from the group consisting of a tollbooth, a vehicular kiosk, a ticket booth, and a smog certification station.

29. A method for conducting a financial transaction comprising:
establishing communication between a pre-registered, key-enabled, personal transaction device (PTD) and a vehicle-accessed, payment-gateway terminal (VAPGT);
receiving a transaction key from the PTD;
transmitting a transaction request to a server; and
receiving a transaction authorization message from the server.

30. The method of claim 29 further comprising:
initiating communication with the VAPGT by the PTD.

31. The method of claim 29 further comprising:
initiating communication with the PTD by the VAPGT.

32. The method of claim 29 further comprising:
combining the transaction key together with a transaction amount and a VAPGT identifier to generate the transaction request.

33. The method of claim 29 further comprising:
receiving an invalid transaction message;
notifying appropriate authorities of the invalid transaction; and
disabling the PTD.

34. The method of claim 29 wherein the server is remotely connected to the VAPGT and PTD.

35. The method of claim 29 wherein the PTD and VAPGT communicate via a wireless connection.

36. The method of claim 29 wherein the PTD is a PKI-enabled PTD.

37. The method of claim 29 wherein the VAPGT is selected from the group consisting of a tollbooth, a vehicular kiosk, a ticket booth, and a smog certification station.

38. A method for conducting a financial transaction comprising:
receiving, at a server, a biometric-controlled, key-enabled, transaction request from a vehicle-accessed, payment-gateway terminal (VAPGT);
determining if the transaction is valid; and
if the transaction is valid,
negotiating with a financial processor to authorize the transaction, and transmitting a transaction authorization message to the VAPGT.

39. The method of claim 38 further comprising:
if the transaction is valid,
selecting a pre-existing account of a plurality of accounts associated with the transaction request.

40. The method of claim 38 wherein determining if the transaction is valid further comprises:
comparing a current transaction type against historical transaction events and pre-established certificates.

41. The method of claim 40 further comprising:
validating a transaction key against existing user keys.

42. The method of claim 38 wherein determining if the transaction is valid further comprises:
comparing a current transaction type against fraud detection systems.

43. The method of claim 38 further comprising:
if the transaction is not valid,
transmitting an invalid transaction message to the VAPGT,
notifying appropriate authorities of the invalid transaction, and
disabling the PTD.

44. The method of claim 38 wherein the server is remotely connected to the VAPGT and PTD.

45. The method of claim 38 wherein the VAPGT is selected from the group consisting of a tollbooth, a vehicular kiosk, a ticket booth, and a smog certification station.

46. A method for conducting a financial transaction comprising:
registering a key-enabled, personal transaction device (PTD) with an appropriate enabling authority, the PTD is uniquely identified with a particular user;
establishing communication between a vehicle-accessed, payment-gateway terminal (VAPGT) and the PTD;
transmitting a payment request to the PTD;
accessing the PTD using a privacy card;
generating a transaction key;
transmitting the transaction key to the VAPGT;
generating a transaction request;
transmitting the transaction request to a server;
determining if the transaction is valid;
if the transaction is valid,
selecting a pre-existing account of a plurality of accounts associated with the transaction key,
negotiating with a financial processor to authorize the transaction,
deducting the transaction amount from the pre-existing account,
transmitting a transaction authorization message to the VAPGT to complete the transaction; and
if the transaction is not valid,
transmitting an invalid transaction message to the VAPGT,
notifying appropriate authorities of the invalid transaction, and
disabling the PTD.

47. The method of claim 46 wherein the privacy card is a biometric control device.

48. The method of claim 46 further comprising:
initiating communication with the VAPGT by the PTD.

49. The method of claim 46 further comprising:
initiating communication with the PTD by the VAPGT.

50. The method of claim 46 wherein determining if the transaction is valid further comprises:
comparing a current transaction type against historical transaction events and pre-established certificates.

51. The method of claim 50 further comprising:
validating the transaction key against existing user keys.

52. The method of claim 51 wherein determining if the transaction is valid further comprises:
comparing a current transaction type against fraud detection systems.

53. The method of claim 46 wherein generating a transaction request further comprises:
combining the transaction key together with a transaction amount and a VAPGT identifier.

54. The method of claim 46 wherein the server is remotely connected to the VAPGT and PTD.

55. The method of claim 46 wherein the PTD and VAPGT communicate via a wireless connection.

56. The method of claim 46 wherein the PTD is a PKI-enabled PTD.

57. The method of claim 46 wherein the VAPGT is selected from the group consisting of a tollbooth, a vehicular kiosk, a ticket booth, and a smog certification station.

58. The method of claim 46 wherein the appropriate enabling authority is selected from the group consisting of a financial institution, a third-party distributor, and a credit card issuer.

59. A method for conducting a financial transaction comprising:
loading a pre-registered, key-enabled, personal transaction device (PTD) with a pre-funded cash account;
establishing communication between a vehicle-accessed, payment-gateway terminal (VAPGT) and the PTD;
accessing the PTD using a privacy card; and
deducting a-transaction amount from the pre-funded cash account to complete the transaction.

60. The method of claim 59 wherein the privacy card is a biometric control device.

61. The method of claim 59 further comprising:
initiating communication with the VAPGT by the PTD.

62. The method of claim 59 further comprising:
initiating communication with the PTD by the VAPGT.

63. The method of claim 59 further comprising:
registering the PTD with an appropriate enabling authority, the PTD is associated with a particular user.

64. The method of claim 63 wherein the appropriate enabling authority is selected from the group consisting of a financial institution, a third-party distributor, and a credit card issuer.

65. The method of claim 59 wherein the PTD and VAPGT communicate via a wireless connection.

66. The method of claim 59 wherein the PTD is a PKI-enabled PTD.

67. The method of claim 59 wherein the VAPGT is selected from the group consisting of a tollbooth, a vehicular kiosk, a ticket booth, and a smog certification station.

68. A method for conducting a financial transaction comprising:
establishing communication between a pre-registered, key-enabled, personal transaction device (PTD) including a pre-loaded, pre-funded cash account and a vehicle-accessed, payment-gateway terminal (VAPGT); and
receiving a transaction authorization message from the PTD to complete the transaction.

69. The method of claim 68 further comprising:
initiating communication with the VAPGT by the PTD.

70. The method of claim 68 further comprising:
initiating communication with the PTD by the VAPGT.

71. The method of claim 68 wherein the PTD and VAPGT communicate via a wireless connection.

72. The method of claim 68 wherein the PTD is a PKI-enabled PTD.

73. The method of claim 68 wherein the VAPGT is selected from the group consisting of a tollbooth, a vehicular kiosk, a ticket booth, and a smog certification station.

74. The method of claim 68 further comprising:
if the transaction is not valid,
notifying appropriate authorities of the invalid transaction, and
disabling the PTD.

75. A method for conducting a financial transaction comprising:
establishing communication between a vehicle-accessed, payment-gateway terminal (VAPGT) and a key-enabled, personal transaction device (PTD);
accessing the PTD using a privacy card; and
transmitting a transaction authorization message to the VAPGT to complete the transaction.

76. The method of claim 75 wherein the privacy card is a biometric control device.

77. The method of claim 75 further comprising:
initiating communication with the VAPGT by the PTD.

78. The method of claim 75 further comprising:
initiating communication with the PTD by the VAPGT.

79. The method of claim 75 further comprising:
registering the PTD with an appropriate enabling authority, the PTD is associated with a particular user.

80. The method of claim 79 wherein the appropriate enabling authority is selected from the group consisting of a financial institution, a third-party distributor, and a credit card issuer.

81. The method of claim 75 wherein the PTD and VAPGT communicate via a wireless connection.

82. The method of claim 75 wherein the PTD is a PKI-enabled PTD.

83. The method of claim 75 wherein the VAPGT is selected from the group consisting of a tollbooth, a vehicular kiosk, a ticket booth, and a smog certification station.

84. The method of claim 75 further comprising:
determining if the transaction is valid.

85. The method of claim 84 further comprising:
if the transaction is valid,
deducting a transaction amount from the pre-funded cash account.

86. The method of claim 84 further comprising:
if the transaction is not valid,
transmitting an invalid transaction message to the VAPGT,
notifying appropriate authorities of the invalid transaction, and
disabling the PTD.

87. A method for conducting a financial transaction comprising:
registering a key-enabled, personal transaction device (PTD) with an appropriate enabling authority, the PTD is uniquely identified with a particular user;
loading the PTD with a pre-funded cash account;
establishing communication between a vehicle-accessed, payment-gateway terminal (VAPGT) and the PTD;
accessing the PTD using a privacy card;
transmitting a transaction request to the PTD;
determining if the transaction is valid;
if the transaction is valid,
deducting a transaction amount from the pre-funded cash account, and
transmitting a transaction authorization message to the VAPGT to complete the transaction; and
if the transaction is not valid,
transmitting an invalid transaction message to the VAPGT,
notifying appropriate authorities of the invalid transaction, and
disabling the PTD.

88. The method of claim 87 wherein the privacy card is a biometric control device.

89. The method of claim 87 further comprising:
initiating communication with the VAPGT by the PTD.

90. The method of claim 87 further comprising:
initiating communication with the PTD by the VAPGT.

91. The method of claim 87 wherein the PTD and VAPGT communicate via a wireless connection.

92. The method of claim 87 wherein the PTD is a PKI-enabled PTD.

93. The method of claim 87 wherein the VAPGT is selected from the group consisting of a tollbooth, a vehicular kiosk, a ticket booth, and a smog certification station.

94. The method of claim 87 wherein the appropriate enabling authority is selected from the group consisting of a financial institution, a third-party distributor, and a credit card issuer.

95. A system to conduct a financial transaction comprising:
a vehicle-accessed, payment-gateway terminal (VAPGT);
a pre-registered, key-enabled, personal transaction device (PTD) in proximity to the VAPGT;
a privacy card connected to the PTD to access the PTD;
a server to receive a transaction request and to send a transaction authorization message to the VAPGT, wherein the VAPGT and PTD complete the transaction upon receipt of the transaction authorization message.

96. The system of claim 95 wherein the privacy card is a biometric control device.

97. The system of claim 95 wherein the PTD initiates communication with the VAPGT.

98. The system of claim 95 wherein the VAPGT initiates communication with the PTD.

99. The system of claim 95 wherein the PTD is registered with an appropriate enabling authority, the PTD is associated with a particular user.

100. The system of claim 99 wherein the appropriate enabling authority is selected from the group consisting of a financial institution, a third-party distributor, and a credit card issuer.

101. The system of claim 95 wherein the PTD generates a transaction key and transmits the key to the VAPGT.

102. The system of claim 101 wherein the VAPGT combines the transaction key together with a transaction amount and a VAPGT identifier to generate the transaction request.

103. The system of claim 95 wherein the server determines if the transaction is valid, and if the transaction is valid, selects a pre-existing account of a plurality of accounts associated with a transaction key, negotiates with a financial processor to authorize the transaction, and deducts a transaction amount from the pre-existing account.

104. The system of claim 103 wherein the server further compares a current transaction type against historical transaction events and pre-established certificates.

105. The system of claim 104 wherein the server further validates the transaction key against existing user keys.

106. The system of claim 103 wherein the server further compares a current transaction type against fraud detection systems.

107. The system of claim 103 wherein, if the transaction is not valid, the server transmits an invalid transaction message to the VAPGT, notifies appropriate authorities of the invalid transaction, and disables the PTD.

108. The system of claim 95 wherein the server is remotely connected to the VAPGT and PTD.

109. The system of claim 95 wherein the PTD and VAPGT communicate via a wireless connection.

110. The system of claim 95 wherein the PTD is a PKI-enabled PTD.

111. The system of claim 95 wherein the VAPGT is selected from the group consisting of a tollbooth, a vehicular kiosk, a ticket booth, and a smog certification station.

112. A system to conduct a financial transaction comprising:
a pre-registered, key-enabled, personal transaction device (PTD) including a pre-loaded, pre-funded cash account;
a vehicle-accessed, payment-gateway terminal (VAPGT) in proximity to the PTD;
a privacy card connected to the PTD used to access the PTD, the PTD deducts a transaction amount from the pre-funded cash account and sends a transaction authorization message to the VAPGT to complete the transaction.

113. The system of claim 112 wherein the privacy card is a biometric control device.

114. The system of claim 112 wherein the PTD initiates communication with the VAPGT.

115. The system of claim 112 wherein the VAPGT initiates communication with the PTD.

116. The system of claim 112 wherein the PTD and VAPGT communicate via a wireless connection.

117. The system of claim 112 wherein the PTD is a PKI-enabled PTD.

118. The system of claim 112 wherein the VAPGT is selected from the group consisting of a tollbooth, a vehicular kiosk, a ticket booth, and a smog certification station.

119. The system of claim 112 wherein the appropriate enabling authority is selected from the group consisting of a financial institution, a third-party distributor, and a credit card issuer.

120. A system for conducting a financial transaction comprising:
means for establishing communication between a vehicle-accessed, payment-gateway terminal (VAPGT) and a pre-registered, key-enabled, personal transaction device (PTD);
means for accessing the PTD using a privacy card;
means for transmitting a transaction request to a server; and
means for receiving a transaction authorization message from the server to complete the transaction.

121. A system for conducting a financial transaction comprising:
means for establishing communication between a vehicle-accessed, payment-gateway terminal (VAPGT) and a pre-registered, key-enabled, personal transaction device (PTD);
means for accessing the PTD using a privacy card; and
means for transmitting a transaction key to the VAPGT.

122. A system for conducting a financial transaction comprising:
means for establishing communication between a pre-registered, key-enabled, personal transaction device (PTD) and a vehicle-accessed, payment-gateway terminal (VAPGT);
means for receiving a transaction key from the PTD;
means for transmitting a transaction request to a server; and
means for receiving a transaction authorization message from the server.

123. A system for conducting a financial transaction comprising:
means for receiving, at a server, a biometric-controlled, key-enabled, transaction request from a vehicle-accessed, payment-gateway terminal (VAPGT);
means for determining if the transaction is valid; and
if the transaction is valid,
means for negotiating with a financial processor to authorize the transaction, and
means for transmitting a transaction authorization message to the VAPGT.

124. A system for conducting a financial transaction comprising:
means for registering a key-enabled, personal transaction device (PTD) with an appropriate enabling authority, the PTD is uniquely identified with a particular user;
means for establishing communication between a vehicle-accessed, payment-gateway terminal (VAPGT) and the PTD;
means for transmitting a payment request to the PTD;
means for accessing the PTD using a privacy card;
means for generating a transaction key;
means for transmitting the transaction key to the VAPGT;
means for generating a transaction request;
means for transmitting the transaction request to a server;
means for determining if the transaction is valid;
if the transaction is valid,
means for selecting a pre-existing account of a plurality of accounts associated with the transaction key,
means for negotiating with a financial processor to authorize the transaction,
means for deducting the transaction amount from the pre-existing account,
means for transmitting a transaction authorization message to the VAPGT to complete the transaction; and
if the transaction is not valid,
means for transmitting an invalid transaction message to the VAPGT,
means for notifying appropriate authorities of the invalid transaction, and
means for disabling the PTD.

125. A system for conducting a financial transaction comprising:
means for loading a pre-registered, key-enabled, personal transaction device (PTD) with a pre-funded cash account;
means for establishing communication between a vehicle-accessed, payment-gateway terminal (VAPGT) and the PTD;
means for accessing the PTD using a privacy card; and
means for deducting a transaction amount from the pre-funded cash account to complete the transaction.

126. A system for conducting a financial transaction comprising:
means for establishing communication between a pre-registered, key-enabled, personal transaction device (PTD) including a pre-loaded, pre-funded cash account and a vehicle-accessed, payment-gateway terminal (VAPGT); and
means for receiving a transaction authorization message from the PTD to complete the transaction.

127. A system for conducting a financial transaction comprising:
means for establishing communication between a vehicle-accessed, payment-gateway terminal (VAPGT) and a key-enabled, personal transaction device (PTD);
means for accessing the PTD using a privacy card; and
means for transmitting a transaction authorization message to the VAPGT to complete the transaction.

128. A system for conducting a financial transaction comprising:
means for registering a key-enabled, personal transaction device (PTD) with an appropriate enabling authority, the PTD is uniquely identified with a particular user;
means for loading the PTD with a pre-funded cash account;
means for establishing communication between a vehicle-accessed, payment-gateway terminal (VAPGT) and the PTD;
means for accessing the PTD using a privacy card;
means for transmitting a transaction request to the PTD;
means for determining if the transaction is valid;
if the transaction is valid,
means for deducting a transaction amount from the pre-funded cash account, and
means for transmitting a transaction authorization message to the VAPGT to complete the transaction; and
if the transaction is not valid,
means for transmitting an invalid transaction message to the VAPGT,
means for notifying appropriate authorities of the invalid transaction, and
means for disabling the PTD.

129. A computer readable medium comprising instructions, which when executed on a processor, perform a method for conducting a financial transaction, the system comprising:
establishing communication between a vehicle-accessed, payment-gateway terminal (VAPGT) and a pre-registered, key-enabled, personal transaction device (PTD);
accessing the PTD using a privacy card;
transmitting a transaction request to a server; and
receiving a transaction authorization message from the server to complete the transaction.

130. A computer readable medium comprising instructions, which when executed on a processor, perform a method for conducting a financial transaction, the system comprising:
means for establishing communication between a vehicle-accessed, payment-gateway terminal (VAPGT) and a pre-registered, key-enabled, personal transaction device (PTD);
means for accessing the PTD using a privacy card; and
means for transmitting a transaction key to the VAPGT.

131. A computer readable medium comprising instructions, which when executed on a processor, perform a method for conducting a financial transaction, the system comprising:
means for establishing communication between a pre-registered, key-enabled, personal transaction device (PTD) and a vehicle-accessed, payment-gateway terminal (VAPGT);
means for receiving a transaction key from the PTD;
means for transmitting a transaction request to a server; and
means for receiving a transaction authorization message from the server.

132. A computer readable medium comprising instructions, which when executed on a processor, perform a method for conducting a financial transaction, the system comprising:
means for receiving, at a server, a biometric-controlled, key-enabled, transaction request from a vehicle-accessed, payment-gateway terminal (VAPGT);
means for determining if the transaction is valid; and
if the transaction is valid,
means for negotiating with a financial processor to authorize the transaction, and
means for transmitting a transaction authorization message to the VAPGT.

133. A computer readable medium comprising instructions, which when executed on a processor, perform a method for conducting a financial transaction, the system comprising:
means for registering a key-enabled, personal transaction device (PTD) with an appropriate enabling authority, the PTD is uniquely identified with a particular user;
means for establishing communication between a vehicle-accessed, payment-gateway terminal (VAPGT) and the PTD;
means for transmitting a payment request to the PTD;
means for accessing the PTD using a privacy card;
means for generating a transaction key;
means for transmitting the transaction key to the VAPGT;
means for generating a transaction request;
means for transmitting the transaction request to a server;
means for determining if the transaction is valid;
if the transaction is valid,
means for selecting a pre-existing account of a plurality of accounts associated with the transaction key,
means for negotiating with a financial processor to authorize the transaction,
means for deducting the transaction amount from the pre-existing account,
means for transmitting a transaction authorization message to the VAPGT to complete the transaction; and
if the transaction is not valid,
means for transmitting an invalid transaction message to the VAPGT,
means for notifying appropriate authorities of the invalid transaction, and
means for disabling the PTD.

134. A computer readable medium comprising instructions, which when executed on a processor, perform a method for conducting a financial transaction, the system comprising:
means for loading a pre-registered, key-enabled, personal transaction device (PTD) with a pre-funded cash account;
means for establishing communication between a vehicle-accessed, payment-gateway terminal (VAPGT) and the PTD;
means for accessing the PTD using a privacy card; and
means for deducting a transaction amount from the pre-funded cash account to complete the transaction.

135. A computer readable medium comprising instructions, which when executed on a processor, perform a method for conducting a financial transaction, the system comprising:
means for establishing communication between a pre-registered, key-enabled, personal transaction device (PTD) including a pre-loaded, pre-funded cash account and a vehicle-accessed, payment-gateway terminal (VAPGT); and
means for receiving a transaction authorization message from the PTD to complete the transaction.

136. A computer readable medium comprising instructions, which when executed on a processor, perform a method for conducting a financial transaction, the system comprising:
means for establishing communication between a vehicle-accessed, payment-gateway terminal (VAPGT) and a key-enabled, personal transaction device (PTD);
means for accessing the PTD using a privacy card; and
means for transmitting a transaction authorization message to the VAPGT to complete the transaction.

137. A computer readable medium comprising instructions, which when executed on a processor, perform a method for conducting a financial transaction, the system comprising:
means for registering a key-enabled, personal transaction device (PTD) with an appropriate enabling authority, the PTD is uniquely identified with a particular user;
means for loading the PTD with a pre-funded cash account;
means for establishing communication between a vehicle-accessed, payment-gateway terminal (VAPGT) and the PTD;
means for accessing the PTD using a privacy card;
means for transmitting a transaction request to the PTD;
means for determining if the transaction is valid;
if the transaction is valid,
means for deducting a transaction amount from the pre-funded cash account, and
means for transmitting a transaction authorization message to the VAPGT to complete the transaction; and
if the transaction is not valid,
means for transmitting an invalid transaction message to the VAPGT,
means for notifying appropriate authorities of the invalid transaction, and
means for disabling the PTD.
